(19) United States
(12) Patent Application Publication
(10) Pub. No.: US 2013/0163082 A1
(43) Pub. Date: Jun. 27, 2013

(54) OPTICAL FILM, MULTILAYER FILM, AND MANUFACTURING METHOD THEREOF

(71) Applicant: Fujifilm Corporation, Tokyo (JP)

(72) Inventors: Takashi TAMADA, Kanagawa (JP); Jun TAKEDA, Kanagawa (JP)

(73) Assignee: FUJIFILM CORPORATION, Tokyo (JP)

(21) Appl. No.: 13/707,072

(22) Filed: Dec. 6, 2012

(30) Foreign Application Priority Data
Dec. 26, 2011 (JP) 2011-283786
Nov. 9, 2012 (JP) 2012-247128

(51) Int. Cl. G02B 5/30

(52) U.S. Cl. CPC G02B 5/3083
USPC 359/489.07; 427/162

(57) ABSTRACT

An optical film that does not cause display unevenness, includes a retardation layer A (A layer) satisfying the following relational expression, nz>nx≧ny here, nx represents an in-plane refractive index in a direction of an in-plane slow axis, ny represents an in-plane refractive index in a direction orthogonal to the direction of an in-plane slow axis, and nz represents a refractive index in a thickness direction; and a retardation layer B (B layer) of which in-plane retardation Re and thickness direction retardation Rth satisfy the following relational expressions: 0 nm≦Re≦20 nm and 50 nm≦Rth≦300 nm, wherein the total film thickness is 5 μm to 40 μm.

### BACKGROUND OF THE INVENTION

1. Field of the Invention

The present invention relates to an optical film that is useful as a retardation film or the like used for a liquid crystal display device, a multilayer film that is used for manufacturing the optical film, and a method that can stably manufacture these films.

2. Description of the Related Art

In the related art, retardation films called, for example, a positive C-plate and a positive B-plate that satisfy nz>nx≧ny when an in-plane refractive index in the direction of an in-plane slow axis is nx, an in-plane refractive index in a direction orthogonal to the direction of an in-plane slow axis is ny, and a refractive index in a thickness direction is nz have been used as a viewing angle compensation film or the like of a liquid crystal display device. The retardation film satisfying the above characteristics is generally used in a liquid crystal display device, as a multilayer structure including retardation layers having other optical characteristics, for example, a negative B-plate or a negative C-plate (for example, JP2000-227520A and JP2009-192611A).

### SUMMARY OF THE INVENTION

However, if the multilayer structure including retardation layers showing the above predetermined optical characteristics is used for compensating a viewing angle of a liquid crystal display device, sometimes display unevenness is caused by change in usage environment such as temperature or humidity, so improvement is required regarding this point.

The present invention has been made in consideration of the above various problems, and an object thereof is to reduce the display unevenness caused by change in temperature and/or humidity in a liquid crystal display device using an optical film including retardation layers satisfying nz>nx≧ny.

Specifically, the present invention aims to provide an optical film including retardation layers that do not cause or cause a small degree of display unevenness resulting from change in temperature and/or humidity and showing the above optical characteristics when used in a liquid crystal display device, and a polarizing plate and a liquid crystal display device including the optical film.

In addition, the present invention aims to provide a multilayer film and a manufacturing method thereof that make it possible to stably manufacture the optical film.

The present inventors conducted examination from various angles regarding the cause of display unevenness resulting from change in temperature and/or humidity. As a result, they found that a retardation film used in a liquid crystal display device is deformed due to temperature and/or humidity, pressure is unevenly applied to the inside of a liquid crystal panel due to the deformed film, and this phenomenon is expressed as display unevenness. Particularly, they could confirm that in a thick retardation film, the rigidity of the whole film tends to increase, so a high stress is caused on the adhered glass plate or the like due to the rigidity of the film, whereby the display unevenness tends to be aggravated. For forming a retardation layer satisfying nz>nx≧ny, materials having negative intrinsic birefringence need to be used. However, many of the materials having negative intrinsic birefringence generally have a molecular structure having a bulky side chain or an aromatic ring in a direction perpendicular to a main chain direction of the molecule, so the film tends to be brittle. It is difficult to make such a brittle film into a thin film, so a technique for making the thin film practically has not been examined in the related art. However, the present inventors conducted examination from various angles and found that by using a solution casting method, a thin film satisfying the above characteristics can be manufactured, and by setting the total thickness of a multilayer film combined with other retardation layers having predetermined optical characteristics to be in a predetermined range, display unevenness can be markedly reduced. In this manner, the present inventors have completed the present invention.

That is, means for solving the above problems are as follows.

[1] An optical film including:
a retardation layer A (A layer) satisfying the following relational expression,

nz>nx≧ny
here, nx represents an in-plane refractive index in a direction of an in-plane slow axis, ny represents an in-plane refractive index in a direction orthogonal to the direction of an in-plane slow axis, and nz represents a refractive index in a thickness direction; and
a retardation layer B (B layer) of which in-plane retardation Re and thickness direction retardation Rth satisfy the following relational expressions,

0 nm≦Re≦20 nm

50 nm≦Rth≦300 nm,
wherein the total film thickness is 5 μm to 40 μm.

[2] The optical film according to aspect [1],
wherein Re and Rth of the A layer satisfy the following relational expressions.

50 nm≦Re≦150 nm

−150 nm≦Rth≦−50 nm

[3] The optical film according to aspect [1] or [2],
wherein Re and Rth of the whole film as a multilayer film satisfy the following relational expression.

0.5≦|Rth|/Re|+0.5≦0.8

[4] The optical film according to any one of aspects [1] to [3],
wherein Re and Rth of the whole film as a multilayer film satisfy the following relational expression.

0.5≦|Rth|/Re|+0.5≦0.7

[5] The optical film according to any one of aspects [1] to [4],
wherein the total film thickness is 5 μm to 30 μm.

[6] The optical film according to any one of aspects [1] to [5],
wherein the B layer contains at least one kind of a discotic liquid crystalline polymer or a polyimide resin.

[7] The optical film according to any one of aspects [1] to [6],
wherein the A layer contains at least one kind selected from a cellulose acylate having an aromatic ring, a styrene-based resin, and a polyester-based resin.

[8] A polarizing plate at least including:
a polarizer; and
the optical film according to any one of aspects [1] to [7].

[9] The polarizing plate according to aspect [8],
wherein the thickness of the polarizer is 10 μm or less.

[10] A liquid crystal display device at least including:
the optical film according to any one of aspects [1] to [7] or the polarizing plate according to aspect [8] or [9].

[11] A multilayer film including:
the optical film according to any one of aspects [1] to [7]; and
a laminate layer C (C layer) on the surface of the A layer of the optical film.

[12] The multilayer film according to aspect [11],
wherein the C layer contains at least one kind of thermoplastic resin.

[13] The multilayer film according to aspect [11] or [12],
wherein the C layer contains at least one kind of cellulose acetate.

[14] A manufacturing method of a multilayer film which is the multilayer film according to any one of aspects [8] to [13], including:
manufacturing a multilayer structure including the A layer and the C layer by a solution co-casting method; and
forming the B layer on the surface of the A layer of the multilayer structure by coating.

[15] A manufacturing method of an optical film which is the optical film according to any one of aspects [1] to [5], including:
preparing the multilayer film according to any one of aspects [8] to [13]; and peeling the C layer from the multilayer film.

[16] The method according to aspect [15], further including forming an adhesive layer on the surface of the A layer exposed due to peeling of the C layer.

According to the present invention, display unevenness that is caused by change in temperature and/or humidity in a liquid crystal display device using an optical film including retardation layers satisfying nz>nx≧ny can be reduced.

Specifically, according to the present invention, an optical film including retardation layers which do not cause or cause a small degree of display unevenness resulting from change in temperature and/or humidity when used in a liquid crystal display device and having the optical characteristics described above, a polarizing plate and a liquid crystal display device including the optical film can be provided.

In addition, according to the present invention, a multilayer film which makes it possible to stably manufacture the optical film and a manufacturing method of the multilayer film can be provided.

### BRIEF DESCRIPTION OF THE DRAWINGS

FIG. 1 is a schematic cross-sectional view of an example of the optical film of the present invention.

FIG. 2 is a schematic cross-sectional view of an example of the multilayer film of the present invention.

FIG. 3 is a schematic cross-sectional view of another example of the optical film of the present invention.

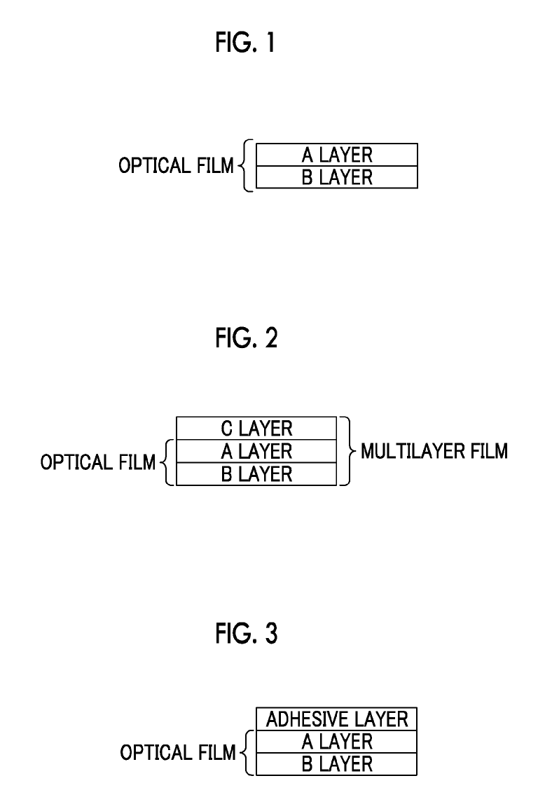

### DESCRIPTION OF THE PREFERRED EMBODIMENTS

Hereinafter, the optical film as well as the manufacturing method thereof and the multilayer film as well as the manufacturing method thereof according to the present invention will be described in detail.

The following constituent elements will be described based on representative embodiments of the present invention in some cases. However, the present invention is not limited to the embodiments. In addition, in the present specification, a range of numerical values described using “to” means a range that includes numerical values described before and after “to” as a lower limit and an upper limit.

[Optical Film]

The optical film of the present invention includes
a retardation layer A (A layer) satisfying the following relational expression,

nz>nx≧ny
here, nx represents an in-plane refractive index in the direction of an in-plane slow axis, ny represents an in-plane refractive index in a direction orthogonal to the direction of an in-plane slow axis, and nz represents a refractive index in the thickness direction; and
a retardation layer B (B layer) of which in-plane retardation Re and thickness direction retardation Rth satisfy the following relational expressions,

0 nm≦Re≦20 nm

50 nm≦Rth≦300 nm,
wherein the total film thickness is 5 μm to 40 μm.

One of the characteristics of the optical film of the present invention is that the total film thickness thereof is 5 μm to 40 μm. Generally, the rigidity of a film tends to increase as the thickness of the film increases. As described above, as the rigidity increases, deformation of the film caused by change in temperature and/or humidity becomes marked. Due to the deformation of film, pressure is unevenly applied to the inside of a liquid crystal panel, and this is one of the causes of display unevenness. In the present invention, by setting the total film thickness to be in the above range, the deformation of film caused by change in temperature and/or humidity is inhibited, whereby the occurrence of display unevenness is reduced. In this respect, the smaller the total film thickness of the optical film of the present invention, the more preferable. On the other hand, handleability of a thin film is poor in manufacturing the film, so the thin film is not preferable in view of manufacturing suitability. Moreover, in order to achieve desired optical characteristics, the film needs to have a certain thickness. In these respects, the total film thickness of the optical film of the present invention is preferably 5-m to 30 μm, and more preferably 10 μm to 30 μm.

The optical film of the present invention has a multilayer structure including the A layer and the B layer that respectively show predetermined optical characteristics.

The A layer is a retardation layer satisfying nz>nx≧ny. For forming a layer satisfying nz>nx≧ny, a solution casting method is effective. Presumably, this is because when a solution of materials as main components is cast onto a support and then dried, the solvent is volatized in the film thickness direction, so compressive stress is caused in the thickness direction of the film, and surface alignment properties of molecular chains are enhanced, whereby the above characteristics may be exhibited. In addition, using the solution casting method is also preferable in the respect that the thin A layer can be manufactured stably by this method.

Examples of the retardation layer satisfying nz>nx≧ny include a so-called positive C-plate (in the present specification, the positive C-plate does not merely refer to a positive C-plate in a strict sense, and includes any types of retardation plates functioning like the C-plate; specifically, the positive C-plate refers to a retardation plate in which Rth has a negative value and Re is 0 nm to 10 nm) and a so-called positive B-plate (in the present specification, the positive B-plate is an optically biaxial retardation plate and has a meaning including any types of optically biaxial retardation plates in which Rth is negative). The optical film satisfying the above characteristics is useful as a viewing angle compensation film of a liquid crystal display device in a horizontal alignment mode, for example, an IPS mode or a FFS mode.

When the optical film is used as a viewing angle compensation film of a liquid crystal display device in a horizontal alignment mode, the B layer is preferably a negative C-plate, in an embodiment in which the A layer is a so-called positive B-plate. On the other hand, in an embodiment in which the A layer is a so-called positive C-plate, the B layer is preferably a negative B-plate.

In an embodiment in which the A layer is a so-called positive B-plate, Re and Rth of the A layer preferably satisfy the following relational expressions which are

50 nm≦Re≦150 nm

−150 nm≦Rth≦−50 nm,
and more preferably satisfy the following expressions.

70 nm≦Re≦130 nm

−130 nm≦Rth≦−70 nm

The B layer is a retardation layer in which Re is 0 nm to 20 nm and Rth is 50 nm to 300 nm (preferably 50 nm to 200 nm, and more preferably 50 nm to 150 nm). Examples of the retardation layer include a so-called negative C-plate (in the present specification, the negative C-plate does not merely refer to a negative C-plate in a strict sense and also includes any types of retardation plates functioning like the C-plate; specifically, the negative C-plate refers to a retardation plate in which Rth has a positive value and Re is 0 nm to 10 nm) and a so-called negative B-plate (in the present specification, the negative B-plate is an optically biaxial retardation plate and has a meaning including any types of optically biaxial retardation plates in which Rth is positive).

In addition, when the optical film is used as a viewing angle compensation film of a liquid crystal display device in a horizontal alignment mode, Rth is preferably within −30 nm to 30 nm, in the optical characteristics measured for the whole film as a multilayer structure including the A layer and the B layer. Specifically, |Rth|/|Re|+0.5 is preferably 0.5 to 0.8, and more preferably 0.5 to 0.7.

(A Layer)

In order that the A layer satisfying the above optical characteristics functions as the positive C-plate, the positive B-plate, or the like and contributes to the compensation of a viewing angle of a liquid crystal display device in a horizontal alignment mode, Rth thereof needs to have somewhat a relatively large negative value. The optical film of the present invention is a thin layered film of which the total film thickness is in the above range. Accordingly, the smaller the thickness of the A layer, the more preferable, and for example, the thickness is preferably 5 μm to 30 μm, more preferably 8 μm to 28 μm, and even more preferably 13 μm to 25 μm. In order to be a thin layer and have Rth that is somewhat relatively largely negative, the optical film preferably contains a material excellently expressing Rth as a main component. Examples of the optical film satisfying the above optical characteristics include various resins described later that have negative intrinsic birefringence. However, in view of the properties of expressing Rth, a polystyrene-based resin, a polyester-based resin, and a cellulose acylate-based resin having an aromatic ring are preferable. In addition, the main component refers to a component that is contained in the largest amount (% by mass) among components constituting the layer.

Hereinafter, polymer materials that are usable as main components for forming the A layer and have negative intrinsic birefringence will be described.

<Polymer Materials Having Negative Intrinsic Birefringence>

The optical film of the present invention contains polymer materials (having a meaning including both resins and polymers) having negative intrinsic birefringence. As the polymer materials having negative intrinsic birefringence, various materials are known, and any of them can be used. However, a polystyrene-based resin, a polyester-based resin, and a cellulose acylate-based resin having an aromatic ring are preferable in the respects that these resins make it possible to manufacture a film by using a solution and excellently express Rth. Hereinafter, these resins will be described in detail, but the present invention is not limited to these resins.

Styrene-Based Resin:

Examples of styrene-based resins usable as a main component of the optical film include polystyrene derivatives and styrene-based copolymers. Specifically, the examples include homopolymers and copolymers of styrene-based monomers. The styrene-based copolymer may be a copolymer of two or more kinds of styrene-based monomers, or a copolymer of one or more kinds of styrene-based monomers with one or more kinds of non-styrene-based monomers (for example, acrylic monomers, and preferably acrylic monomers represented by the following Formula (c)).

Examples of the styrene-based monomer include a monomer in which one or more hydrogen atoms of an ethenyl group included in styrene have been substituted with a substituent, and a monomer in which one or more hydrogen atoms of a phenyl group included in styrene have been substituted with a substituent. The styrene-based monomer is preferably a styrene-based monomer having a substituent in a phenyl group. Examples of the substituent include an alkyl group, a halogen atom, an alkoxy group, a carboxyl group such as an acetoxy group, an amino group, a nitro group, a cyano group, an aryl group, a hydroxyl group, a carbonyl group, and the like. Among these, a hydroxyl group, a carbonyl group, or an acetoxy group is preferable, and a hydroxyl group or an acetoxy group is more preferable. In addition, the substituent may be used alone, or two or more substituents may be used. The substituent may or may not further have a substituent. Moreover, the styrene-based derivative monomer may have a structure in which a phenyl group is further condensed with other aromatic rings, or may have indenes or indanes as a substituent so as to form a ring other than a phenyl group, or may have a structure having a bridged ring.

The styrene-based monomer is preferably an aromatic vinyl-based monomer represented by the following General Formula (b).

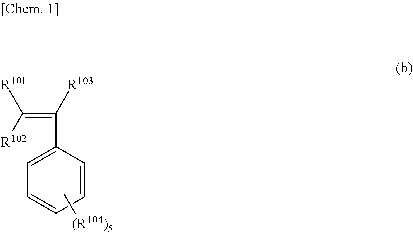

In the formula, each of R¹⁰¹ to R¹⁰⁴ independently represents a substituted or unsubstituted hydrocarbon group having 1 to 30 carbon atoms that may have a linking group including a hydrogen atom, a halogen atom, an oxygen atom, a sulfur atom, a nitrogen atom, or a silicon atom or represents a polar group, all of R¹⁰⁴ may be atoms or groups that may be the same as or different from each other or may form carbon rings or heterocycles (these carbon rings or heterocycles may have a monocyclic structure or may form a polycyclic structure by being condensed with other rings) by binding to each other.

Specific examples of the aromatic vinyl-based monomer include styrene; alkyl-substituted styrenes such as α-methylstyrene, β-methylstyrene, and p-methylstyrene; halogen-substituted styrenes such as 4-chlorostyrene and 4-bromostyrene; hydroxystyrenes such as p-hydroxystyrene, α-methyl-p-hydroxystyrene, 2-methyl-4-hydroxystyrene, and 3,4-dihydroxystyrene; vinylbenzyl alcohols; alkoxy-substituted styrenes such as p-methoxystyrene, p-tert-butoxystyrene, and m-tert-butoxystyrene; vinylbenzoates such as 3-vinylbenzoate and 4-vinylbenzoate; vinyl benzoic acid esters such as methyl-4-vinylbenzoate and ethyl-4-vinylbenzoate; 4-vinylbenzyl acetate; 4-acetoxystyrene; amide styrenes such as 2-butylamide styrene, 4-methylamide styrene, and p-sulfonamide styrene; aminostyrenes such as 3-aminostyrene, 4-aminostyrene, 2-isopropenyl aniline, and vinylbenzyl dimethylamine; nitrostyrenes such as 3-nitrostyrene and 4-nitrostyrene; cyanostyrenes such as 3-cyanostyrene and 4-cyanostyrene; vinyl phenyl acetonitrile; aryl styrenes such as phenyl styrene; indenes, and the like, but the present invention is not limited to these specific examples. These monomers may be used as two or more kinds of copolymerization components.

The above acrylic monomer can be selected from, for example, monomers represented by the following Formula (c).

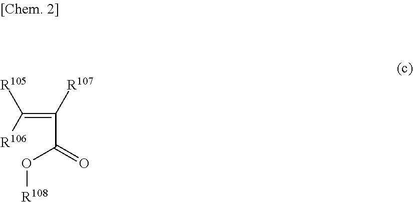

In the formula, each of R¹⁰⁵ to R¹⁰⁸ independently represents a substituted or unsubstituted hydrocarbon group having 1 to 30 carbon atoms that may have a linking group including a hydrogen atom, a halogen atom, an oxygen atom, a sulfur atom, a nitrogen atom, or a silicon atom or represents a polar group.

Examples of the acrylic acid ester-based monomer include methyl acrylate, ethyl acrylate, (i- or n-)propyl acrylate, (n-, i-, s-, or tert-)butyl acrylate, (n-, i-, or s-)pentyl acrylate, (n- or i-)hexyl acrylate, (n- or i-)heptyl acrylate, (n- or i-)octyl acrylate, (n- or i-)nonyl acrylate, (n- or i-)myristyl acrylate, (2-ethylhexyl)acrylate, (ε-caprolactone)acrylate, (2-hydroxyethyl)acrylate, (2-hydroxypropyl)acrylate, (3-hydroxypropyl)acrylate, (4-hydroxybutyl)acrylate, (2-hydroxybutyl)acrylate, (2-methoxyethyl)acrylate, (2-ethoxyethyl)acrylate, phenyl acrylate, phenyl methacrylate, (2- or 4-chlorophenyl)acrylate, (2- or 4-chlorophenyl)methacrylate, (2-, 3-, or 4-ethoxycarbonylphenyl)acrylate, (2-, 3-, or 4-ethoxycarbonylphenyl)methacrylate, (o- m-, or p-tolyl)acrylate, (o-, m-, or p-tolyl)methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, and monomers obtained by changing the above acrylic acid esters into methacrylic acid esters, but the present invention is not limited to these specific examples. These monomers may be used as two or more kinds of copolymerization components. Among these, methyl acrylate, ethyl acrylate, (i- or n-)propyl acrylate, (n-, i-, s-, or tert-)butyl acrylate, (n-, i- or s-)pentyl acrylate, (n- or i-)hexyl acrylate, and monomers obtained by changing the above acrylic acid esters into methacrylic acid esters are preferable, in the respects that these are easily obtained industrially and inexpensive.

Examples of other copolymerization components include acid anhydrides such as maleic anhydride, citraconic anhydride, cis-1-cyclohexene-1,2-dicarboxylic anhydride, 3-methyl-cis-1-cyclohexene-1,2-dicarboxylic anhydride, and 4-methyl-cis-1-cyclohexene-1,2-dicarboxylic anhydride; nitrile group-containing radically polymerizable monomers such as acrylonitrile and methacrylonitrile; amide bond-containing radically polymerizable monomers such as acrylamide, methacrylamide, trifluoromethanesulfonyl aminoethyl (meth)acrylate; aliphatic vinyls such as vinyl acetate; chlorine-containing radically polymerizable monomers such as vinyl chloride and vinylidene chloride; and conjugated diolefins such as 1,3-butadiene, isoprene, and 1,4-dimethylbutadiene, but the present invention is not limited to these.

Polyester Resin:

Examples of the polyester resin usable as a main component of the optical film include fumaric acid ester-based resins that are disclosed in JP2008-112141A and known as materials having negative intrinsic birefringence. Examples of the fumaric acid ester-based resin include fumaric acid ester polymers, and among these, a fumaric acid diester-based resin including 50 mol % or more of the unit of a fumaric acid diester residue represented by General Formula (a) is preferable.

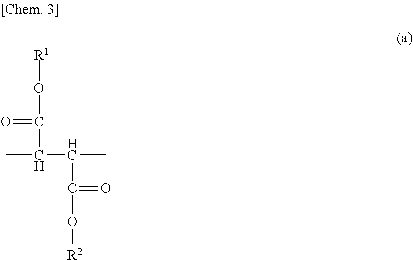

In the formula, each of R¹ and R² independently represents branched or cyclic alkyl having 3 to 12 carbon atoms.

Each of R¹ and R² as an ester substituent of the unit of a fumaric acid diester residue independently represents a branched or cyclic alkyl group having 3 to 12 carbon atoms, and may be substituted with a halogen group such as fluorine or chloride, an ether group, an ester group, or an amino group. Examples of R¹ and R² include an isopropyl group, a s-butyl group, a t-butyl group, a s-pentyl group, a t-pentyl group, a s-hexyl group, a t-hexyl group, a cyclopropyl group, a cyclopentyl group, a cyclohexyl group, and the like. Among these, an isopropyl group, a s-butyl group, a t-butyl group, a cyclopentyl group, a cyclohexyl group, and the like are preferable, and an isopropyl group is more preferable.

Examples of the unit of a fumaric acid diester residue represented by General Formula (a) include a diisopropyl fumarate residue, a di-s-butyl fumarate residue, a di-t-butyl fumarate residue, a di-s-pentyl fumarate residue, a di-t-pentyl fumarate residue, a di-s-hexyl fumarate residue, a di-t-hexyl fumarate residue, a dicyclopropyl fumarate residue, a dicyclopentyl fumarate residue, a dicyclohexyl fumarate residue, and the like. Among these, a diisopropyl fumarate residue, a di-s-butyl fumarate residue, a di-t-butyl fumarate residue, a dicyclopentyl fumarate residue, a dicyclohexyl fumarate residue, and the like are preferable, and a diisopropyl fumarate residue is particularly preferable.

As a main component of the A layer, a fumaric acid ester-based resin including 50 mol % or more of the unit of a fumaric acid diester residue represented by General Formula (a) is preferably used, and a resin including 50 mol % or more of the unit of a fumaric acid diester residue represented by General Formula (a) and 50 mol % or less of a residue unit including a monomer that is copolymerizable with fumaric acid diesters is more preferable. Examples of the residue unit including a monomer that is copolymerizable with fumaric acid diesters include one or two or more kinds of residues of styrenes such as a styrene residue and an α-methylstyrene residue; residues of acryls; residues of acrylic acid esters such as a methyl acrylate residue, an ethyl acrylate residue, a butyl acrylate residue, a 3-ethyl-3-oxetanyl methyl acrylate residue, and a tetrahydrofurfuryl acrylate residue; methacrylic acid residues; residues of methacrylic acid esters such as a methyl methacrylate residue, an ethyl methacrylate residue, a butyl methacrylate residue, a 3-ethyl-3-oxetanyl methyl methacrylate residue, and a tetrahydrofurfuryl methacrylate residue; residues of vinyl esters such as a vinyl acetate residue and a vinyl propionate residue; acrylonitrile residues; methacrylonitrile residues; and residues of olefins such as an ethylene residue and a propylene residue. Among these, a 3-ethyl-3-oxetanyl methyl acrylate residue and a 3-ethyl-3-oxetanyl methyl methacrylate residue are preferable, and a 3-ethyl-3-oxetanyl methyl acrylate residue is particularly preferable. Among these, a resin including 70 mol % or more of the unit of a fumaric acid diester residue represented by General Formula (a) is preferable, a resin including 80 mol % or more of the unit is more preferable, and a resin including 90 mol % or more of the unit is even more preferable. Needless to say, a resin including only the unit of a fumaric acid diester residue represented by General Formula (a) is also preferable.

The fumaric acid ester-based resin used as a main component of the A layer preferably has a number average molecular weight (Mn) of 1×10⁴ or more in terms of standard polystyrene obtained by an elution curve measured by Gel Permeation Chromatography (hereinafter, described as GPC). Particularly, the number average molecular weight is preferably from 2×10⁴ to 2×10⁵, since an optical film having excellent mechanical characteristics and molding processability in manufacturing the film is obtained in this range.

Various methods can be employed as the manufacturing method of the fumaric acid ester-based resin without particular limitation. For example, by using fumaric acid diesters or by concurrently using a monomer copolymerizable with fumaric acid diesters in some cases, radical polymerization or radical copolymerization is performed, whereby the fumaric acid ester-based resin can be manufactured. Examples of the fumaric acid diesters used as a raw material include diisopropyl fumarate, di-s-butyl fumarate, di-t-butyl fumarate, di-s-pentyl fumarate, di-t-pentyl fumarate, di-s-hexyl fumarate, di-t-hexyl fumarate, dicyclopropyl fumarate, dicyclopentyl fumarate, dicyclohexyl fumarate, and the like. Examples of the monomer copolymerizable with the fumaric acid diester include one or two or more kinds of styrenes such as styrene and α-methylstyrene; acrylic acid; acrylic acid esters such as methyl acrylate, ethyl acrylate, butyl acrylate, 3-ethyl-3-oxetanyl methyl acrylate, and tetrahydrofurfuryl acrylate; methacrylic acid; methacrylic acid esters such as methyl methacrylate, ethyl methacrylate, butyl methacrylate, 3-ethyl-3-oxetanyl methyl methacrylate, and tetrahydrofurfuryl methacrylate; vinyl esters such as vinyl acetate and vinyl propionate; acrylonitrile; methacrylonitrile; and olefins such as ethylene and propylene. Among these, 3-ethyl-3-oxetanyl methyl acrylate and 3-ethyl-3-oxetanyl methyl methacrylate are preferable, and 3-ethyl-3-oxetanyl methyl acrylate is particularly preferable.

In addition, the radical polymerization can be performed using known polymerization methods, and for example, any of a mass polymerization method, a solution polymerization method, a suspension polymerization method, a precipitation polymerization method, an emulsion polymerization method, and the like can be employed.

Examples of a polymerization initiator used for performing the radical polymerization include organic peroxides such as benzoyl peroxide, lauryl peroxide, octanoyl peroxide, acetyl peroxide, di-t-butyl peroxide, t-butyl cumyl peroxide, dicumyl peroxide, t-butyl peroxyacetate, t-butyl peroxybenzoate, and t-butyl peroxypivalate; and azo-based initiators such as 2,2′-azobis(2,4-dimethylvaleronitrile), 2,2′-azobis(2-butyronitrile), 2,2′-azobisisobutyronitrile, dimethyl-2,2′-azobisisobutyrate, and 1,1′-azobis(cyclohexane-1-carbonitrile).

There is no particular limitation on a solvent usable in the solution polymerization method, suspension polymerization method, precipitation polymerization method, and emulsion polymerization method. Examples of the solvent include aromatic solvents such as benzene, toluene, and xylene; alcohol-based solvents such as methanol, ethanol, propyl alcohol, and butyl alcohol; cyclohexane; dioxane; tetrahydrofuran (THF); acetone; methyl ethyl ketone; dimethylformamide; isopropyl acetate; water; and a mixed solvent of these.

A polymerization temperature in performing radical polymerization can be appropriately set according to a temperature at which the polymerization initiator is decomposed. Generally, the radical polymerization is preferably performed at a temperature ranging from 40° C. to 150° C.

One or more kinds of surfactants may be added to the optical film (particularly, optical film containing a polyester resin). Regarding examples of the usable additives and a preferable range of the amount of the additives added, Paragraphs [0033] to [0041] and the like in JP2009-168900A can be referred to.

Cellulose Acylate-Based Resin Including Aromatic Ring:

The cellulose acylate-based resin including an aromatic ring that is usable as a main component of the optical film is a resin in which at least a portion of hydroxyl atoms of OH groups in cellulose molecules as a raw material has been substituted with an acyl group having an aromatic group. The cellulose as a raw material include cotton linters, wood pulp (broad-leaved tree pulp or needle-leaved tree pulp), and the like, and cellulose acylate obtained from any type of raw material cellulose can be used. In some cases, the cellulose can be used by being mixed. For example, cellulose disclosed in Marusawa, Uda, “Plastic material course (17), cellulose-based resin”, Nikkan Kogyo Shimbun (1970) or the technical report published by the Japan Institute of Invention and Innovation, publication No. 2001-1745 (pp 7-8) can be used.

As the above aromatic acyl group, an acyl group having a substituted or unsubstituted phenyl or naphthyl group is preferable, and an acyl group having a substituted or unsubstituted phenyl group is more preferable. Examples of the substituent include an alkyl group having 1 to 6 carbon atoms, an alkoxy group having 1 to 6 carbon atoms, and a halogen atom. The aromatic acyl group preferably has 7 to 14 carbon atoms, more preferably has 7 to 8 carbon atoms, and particularly preferably has 7 carbon atoms. Examples of preferable aromatic acyl groups include a benzoyl group, a 4-chlorobenzoyl group, a 4-methylbenzoyl group, a 4-methoxybenzoyl group, a 2-methylbenzoyl group, a 2-methoxybenzoyl group, a 3-methylbenzoyl group, a 3-methoxybenzoyl group, and the like.

The above cellulose acylate-based resin preferably has an aliphatic acyl group in addition to the aromatic acyl group. The aliphatic acyl group preferably has 2 to 7 carbon atoms, more preferably has 2 to 6 carbon atoms, even more preferably has 2 to 5 carbon atoms, and still more preferably has 2 to 4 carbon atoms. The aliphatic acyl group is particularly preferably an acetyl group having 2 carbon atoms. Examples of the aliphatic acyl group include an alkylcarbonyl group, an alkenylcarbonyl group, an alkynylcarbonyl group, and the like. Examples of preferable aliphatic acyl groups include an acetyl group, a propionyl group, a butyryl group, a pentanoyl group, a heptanoyl group, a hexanoyl group, an isobutyryl group, a pivaloyl group, a cyclohexane carbonyl group, and the like, and among these, an acetyl group is particularly preferable.

A substitution degree A of the cellulose acylate-based resin substituted with the aromatic acyl group is preferably 0.8 to 2.0, and more preferably 1.0 to 1.8. On the other hand, a substitution degree B of the cellulose acylate-based resin substituted with the aliphatic acyl group is preferably 0.7 to 1.9, and more preferably 0.9 to 1.7. A total substitution degree A+B is preferably 1.5 to 3.0, and more preferably 1.7 to 2.8. If the substitution degree is in this range, both excellent solution film-forming property and excellent Rth expression property are obtained.

<Other Polymer Materials Having Negative Intrinsic Birefringence>

In addition to the above resins, examples of polymer materials that are usable as a main component of the A layer and has negative intrinsic birefringence include polycarbonates and acrylic resins. These resins are inferior to the above resins in terms of the Rth expression properties, but are preferable for the use that requires low Rth. Hereinafter, specific examples of the usable acrylic resin will be described.

Acrylic Resin:

As the acrylic resin usable as a main component of the A layer, resins having a number average molecular weight of equal to or more than 1,000 and less than 2,000,000 are preferable, resins having a number average molecular weight of 5,000 to 1,000,000 are more preferable, and resins having a number average molecular weight of 8,000 to 500,000 are even more preferable.

Examples of the acrylic resin include polymers containing a structural unit obtained from an acrylic acid ester-based monomer represented by the following General Formula (2).

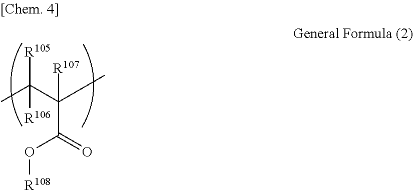

In the formula, each of R¹⁰⁵ to R¹⁰⁸ independently represents a substituted or unsubstituted hydrocarbon group having 1 to 30 carbon atoms that may have a linking group including a hydrogen atom, a halogen atom, an oxygen atom, a sulfur atom, a nitrogen atom, or a silicon atom or represents a polar group.

Examples of the acrylic acid ester-based monomer include methyl acrylate, ethyl acrylate, (i- or n-)propyl acrylate, (n-, i-, s-, or tert-)butyl acrylate, (n-, i-, or s-)pentyl acrylate, (n- or i-)hexyl acrylate, (n- or i-)heptyl acrylate, (n- or i-)octyl acrylate, (n- or i-)nonyl acrylate, (n- or i-)myristyl acrylate, (2-ethylhexyl)acrylate, (ε-caprolactone) acrylate, (2-hydroxyethyl)acrylate, (2-hydroxypropyl)acrylate, (3-hydroxypropyl)acrylate, (4-hydroxybutyl)acrylate, (2-hydroxybutyl)acrylate, (2-methoxyethyl)acrylate, (2-ethoxyethyl)acrylate, phenyl acrylate, phenyl methacrylate, (2- or 4-chlorophenyl)acrylate, (2- or 4-chlorophenyl)methacrylate, (2-, 3-, or 4-ethoxycarbonylphenyl)acrylate, (2-, 3-, or 4-ethoxycarbonylphenyl)methacrylate, (o- m-, or p-tolyl)acrylate, (o-, m-, or p-tolyl)methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, and monomers obtained by changing the above acrylic acid esters into methacrylic acid esters, but the present invention is not limited to these specific examples. These monomers may be used as two or more kinds of copolymerization components. Among these, methyl acrylate, ethyl acrylate, (i- or n-)propyl acrylate, (n-, i-, s-, or tert-)butyl acrylate, (n-, i- or s-)pentyl acrylate, (n- or i-)hexyl acrylate, and monomers obtained by changing the above acrylic acid esters into methacrylic acid esters are preferable, in the respects that these are easily obtained industrially and inexpensive.

As the acrylic acid ester-based monomer, commercially available products, for example, “DIANAL BR88” (manufactured by Mitsuibishi Rayon Co., Ltd.) and the like can be used.

(B Layer)

The optical film of the present invention is a thin film of which the total film thickness is in the above range. Accordingly, the smaller the thickness of the B layer, the more preferable. For example, the thickness of the B layer is preferably 0.5 μm to 20 μm, more preferably 0.7 μm to 10 μm, and even more preferably 1.0 μm to 5.0 μm. A thin layer having the thickness in the above range can be formed by, for example, coating. On the other hand, in order to satisfy the above optical characteristics required for the B layer by using a retardation layer having the thickness in the above range, it is preferable to use a material that excellently expresses Rth. Therefore, as a main component of the B layer, a material that can form a layer by coating and excellently express positive Rth is preferable. Examples of materials that can form a retardation layer showing Rth which is somewhat largely positive by coating include liquid crystal compounds and polymer materials. As the liquid crystal compound, a discotic liquid crystalline compound is preferable, and as the polymer material, a polyimide resin is preferable. Hereinafter, the materials usable as a main component of the B layer will be described in detail.

<Discotic Liquid Crystalline Compound>

Examples of the discotic liquid crystalline compound that are usable for forming the B layer include compounds disclosed in various documents (C. Destrade et al., Mol. Crysr. Liq. Cryst., vol. 71, p. 111 (1981); The Chemical Society of Japan, quarterly journal of “Chemistry Review”, No. 22, Chemistry of Liquid Crystals, Chapter 5, Chapter 10, Paragraph 2 (1994); B. Kohne et al., Angew. Chem. Soc. Chem. Comm., p. 1794 (1985); J. Zhang et al., J. Am. Chem. Soc., vol. 116, p. 2655 (1994)).

The discotic liquid crystalline compound preferably has a polymerizable group such that this compound can be fixed by polymerization. For example, a structure in which a polymerizable group is bonded as a substituent to a disk-like core of the discotic liquid crystalline compound is considered. However, if the polymerizable group is directly bonded to the disk-like core, it is difficult to maintain the aligned state during the polymerization reaction. Therefore, a structure having a linking group between the disk-like core and the polymerizable group is preferable. That is, the discotic liquid crystalline compound having a polymerizable group is preferably a compound represented by the following formula.

D(-L-P)ₙ

In the formula, D represents a disk-like core, L represents a divalent linking group, P represents a polymerizable group, and n represents an integer of 1 to 12. Specific preferable examples of the disk-like core (D), divalent linking group (L), and polymerizable group (P) in the formula respectively include (D) to (D15), (L1) to (L25), and (P1) to (P18) disclosed in JP2001-4837A, and the content disclosed in this gazette can be preferably used. In addition, a discotic nematic liquid crystalline phase-solid phase transition temperature of the liquid crystalline compound is preferably 30° C. to 300° C., and more preferably 30° C. to 170° C.

If the discotic liquid crystalline compound represented by the following Formula (I) is contained in a coating liquid, viscosity of the liquid tends to be low relatively, so the liquid is preferable in view of excellent coating properties. In view of the property of expressing optical characteristics, the compound is also preferable.

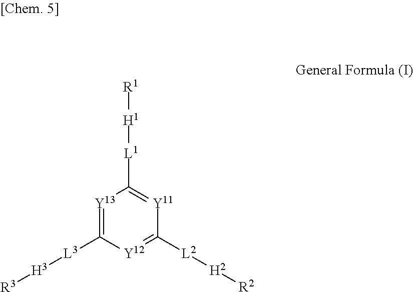

In the formula, each of Y¹¹, Y¹², and Y¹³ independently represents methine or a nitrogen atom which may be substituted; each of L¹, L², and L³ independently represents a single bond or a divalent linking group; each of H¹, H², and H³ independently represents a group represented by General Formula (I-A) or (I-B); and each of R¹, R², and R³ independently represents the following General Formula (I-R).

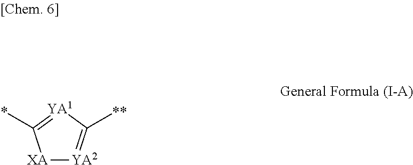

In General Formula (I-A), each of YA¹ and YA² independently represents methine or a nitrogen atom; XA represents an oxygen atom, a sulfur atom, methine, or imino; * represents a position binding to L¹ to L³ in the General Formula (I); and ** represents a position binding to R¹ to R³ in the General Formula (I).

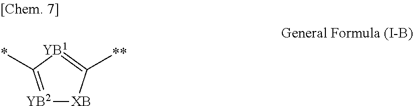

In General Formula (I-B), each of YB¹ and YB² independently represents methine or a nitrogen atom; XB represents an oxygen atom, a sulfur atom, methine, or imino; * represents a position binding to L¹ to L³ in the General Formula (I); and ** represents a position binding to R¹ to R³ in the General Formula (I).

*-(-L²¹-Q²)ₙ₁-L²²-L²³-Q¹ General Formula (I-R)

In General Formula (I-R), * represents a position binding to H¹ to H³ in General Formula (I); L²¹ represents a single bond or a divalent linking group; Q² represents a divalent group (cyclic group) having at least one kind of cyclic structure; n1 represents an integer of 0 to 4; L²² represents **—O—, **—O—CO—, **—CO—O—, **—O—CO—O—, **—S—, **—NH—, **—SO₂—, **—CH₂—, **—CH═CH—, or **—C≡C—; L²³ represents —O—, —S—, —C(═O)—, —SO₂—, —NH—, —CH₂—, —CH═CH—, —C≡C—, and a divalent linking group selected from a group including combinations of these; and Q¹ represents a polymerizable group or a hydrogen atom.

Regarding preferable ranges of the respective symbols of the tri-substituted benzene-based discotic liquid crystalline compound represented by the Formula (I) and specific examples of the compound of the Formula (I), the disclosure of Paragraphs [0013] to [0077] in JP2010-244038A can be referred to. Here, the discotic liquid crystalline compound usable in the present invention is not limited to the tri-substituted benzene-based discotic liquid crystalline compound of the Formula (I).

Examples of triphenylene compounds include the compounds disclosed in Paragraphs [0062] to [0067] in JP2007-108732A, but the present invention is not limited thereto.

The B layer satisfying the above optical characteristics can be formed by fixing discotic liquid crystals in a state where the crystal molecules are aligned horizontally. Herein, the words “aligned horizontally” means that discotic liquid crystal molecules are in a state of being aligned while the disk surface thereof is in parallel with the layer surface. In order to establish such an alignment state, one or more kinds of additives (a horizontal alignment promoter) may be added. The horizontal alignment promoter of liquid crystalline compounds is disclosed in JP1999-352328A (JP-H11-352328A), JP2000-105315A, and JP2002-20363A respectively. In the present invention, as the horizontal alignment promoter used for forming the B layer, a compound having a 1,3,5-triazine ring is preferable. The compound having a 1,3,5-triazine ring is preferably represented by the following Formula (II). The compound represented by the following Formula (II) is disclosed in Paragraphs [0035] to [0106] of JP2004-177813A in detail, therefore that document can be referred to.

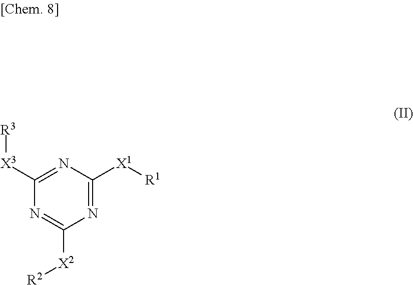

In addition, examples of the horizontal alignment promoter usable for forming the B layer in the present invention also include horizontal alignment promoters for air interface, such as compounds respectively represented by the following two formulae. The compounds respectively represented by the following two formulae are disclosed in Paragraphs [0023] to [0042] in JP2002-62425A in detail, therefore that document can be referred to Moreover, in order to stably create the horizontal alignment state, an alignment layer may also be used.

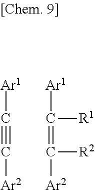

A liquid crystal composition used for forming the B layer is preferably curable, and preferably a composition that can be cured by a polymerization reaction or a crosslinking reaction. A polymerization initiator or a polymerizable monomer may be added to the composition separately. Moreover, in order to improve coating properties, a surfactant and the like may be added.

The B layer can be formed by, for example, coating a curable composition that is prepared as a coating liquid and contains at least discotic liquid crystal molecules onto the surface of the A layer or the like, horizontally aligning molecules of the discotic liquid crystalline compound while varying temperature if desired, and fixing the aligned state by causing a curing reaction. In this example, if the thickness of the layer is about 0.5 μm to 10 μm, the optical characteristics required for the B layer are satisfied.

<Polyimide Resin>

A weight average molecular weight (Mw) of the polyimide resin usable for forming the B layer is preferably in a range of from 1,000 to 1,000,000, and more preferably in a range of from 2,000 to 500,000. The weight average molecular weight can be measured by, for example, Gel Permeation Chromatography (GPC) by using polyethylene oxide as a standard reagent and DMF as a solvent.

As the polyimide, polyimide that exhibits excellent in-plane alignment properties and is soluble in an organic solvent is preferable. Specifically, the polymer which is disclosed in JP2000-511296A, contains a product of condensation polymerization between 9,9-bis(aminoaryl)fluorene and an aromatic tetracarboxylic dianhydride, and contains one or more repeating units represented by the following Formula (1) can be used.

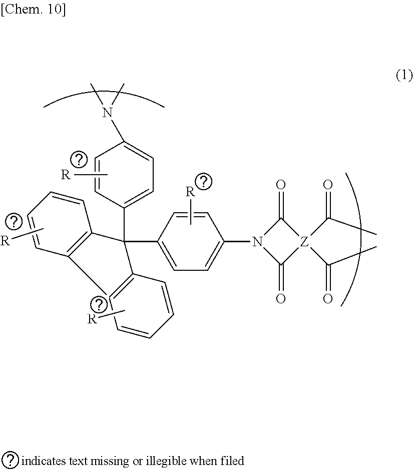

In addition to the above polymer, for example, the homopolymer of which the repeating unit is represented by the following General Formula (3), the polyimide of which the repeating unit is represented by the following General Formula (5), and the like that are disclosed in JP1996-511812A (JP-H8-511812A) are exemplified. In addition, the polyimide of the following Formula (5) is a preferable form of the homopolymer of the following Formula (3).

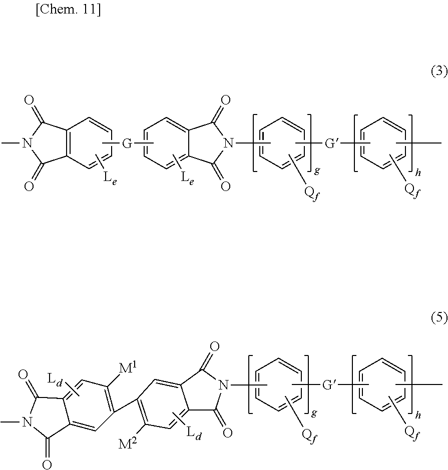

Examples of the polyimide also include copolymers that are obtained by appropriately copolymerizing acid dianhydrides or diamines having structures other than the above skeleton (repeating unit) described above. Examples of the acid dianhydrides include aromatic tetracarboxylic dianhydride. Examples of the aromatic tetracarboxylic dianhydride include pyromellitic dianhydride, benzophenone tetracarboxylic dianhydride, naphthalene tetracarboxylic dianhydride, heterocyclic aromatic tetracarboxylic dianhydride, 2,2′-substituted biphenyl tetracarboxylic dianhydride, and the like. Examples of the diamines include aromatic diamines, and specific examples thereof include benzenediamine, diaminobenzophenone, naphthalenediamine, heterocyclic aromatic diamines, and other aromatic diamines.

The B layer can be formed by, for example, coating a coating liquid that is prepared by dissolving a polyimide resin in a solvent onto the surface of the A layer or the like, and drying the resultant by heating if desired. In this example, if the thickness of the layer is about 1.0 μm to 5.0 μm, optical characteristics required for the B layer are satisfied.

<Polymer Material as Another Main Component of B Layer>

The materials used as a main component of the B layer are not limited to the above examples, and various materials can be selected from polymer materials and the like that exhibit optical uniaxial properties, that is, exhibit retardation only in the thickness direction. Examples of the material include polycarbonate and the like.

In the embodiment in which the B layer is a retardation layer formed by coating as described above, the A layer preferably functions as a support film of the B layer. It is preferable that the B layer be formed by coating a coating liquid for forming the B layer onto the surface of the A layer and drying the resultant. In addition, the B layer may be a retardation film having self-supporting properties, and this retardation film may be pasted onto the surface of the A layer by using an adhesive or a glue.

[Multilayer Film]

The present invention also relates to a multilayer film that has the optical film of the present invention and a laminate layer C (C layer) on the surface of the A layer of the optical film. As described above, the A layer is preferably a thin layer. However, there is a tendency that as the thickness of a film decreases, the more the handleability worsens in manufacturing the film. Moreover, in the embodiment in which the B layer is formed by coating, if the A layer is a thin layer (for example, 5 μm to 30 μm), the strength of the B layer as a support film becomes insufficient, so coating cannot be stably performed in some cases. If an embodiment of a multilayer film having the C layer is employed, deterioration of handleability in manufacturing the film that is caused by the small thickness of the A layer, and the problem of insufficient strength of a support that is caused in forming the B layer can be solved.

In the multilayer film, the C layer may be finally peeled from the optical film. In this embodiment, an interlayer peeling force between the A layer and the C layer of the optical film is preferably 0.05 N/cm to 5 N/cm. If the interlayer peeling force is in this range, excellent adhesiveness by which peeling is not caused is maintained when the film is formed, and at the time of use, excellent peeling properties by which the optical film is easily peeled from the C layer so as to become usable are exhibited. In this manner, excellent handleability can be maintained when the film is formed using a solution, and at the time of use, the optical film can be used for various purposes by being cut off from the C layer. The interlayer peeling force between the A layer and the C layer is preferably 0.1 N/cm to 4 N/cm, and more preferably 0.2 N/cm to 3 N/cm.

The interlayer peeling force between the A layer and the C layer is influenced by the affinity of polymer materials used as main components for the A layer and the C layer respectively. The adhesiveness between layers using main components that share high affinity with each other becomes high, that is, the interlayer peeling force is strengthened. On the other hand, the adhesiveness between layers using main components that share low affinity with each other is lowered, that is, the interlayer peeling force is weakened. When the polymer material of which a predetermined intrinsic birefringence is negative is used as a main component of the A layer, if a material such as cellulose ester having a certain degree of high hydrophilicity is used as a main component of the C layer, the interlayer peeling force can be adjusted to be in the above range. In addition, the interlayer peeling force can be adjusted to be in the above range not only by the main component, but also by adjusting the type or amount of the additives added to the respective layers. The interlayer peeling force can also be adjusted via solvent species or solvent composition of dopes for forming the respective layer at the time of manufacturing a film by using a solution.

The elastic modulus of the C layer is higher than that of the A layer. However, in the embodiment in which the A layer is a thin layer having a film thickness in the above range, the deterioration of handleability in a solution casting method can be improved, so this embodiment is preferable. If ΔE′ as a difference in an elastic modulus E′ (GPa) between the C layer and the A layer is 0.2 GPa or more, the above effects can be obtained. The ΔE′ is more preferably 0.4 GPa or more. For example, the elastic modulus of cellulose acetate is about 3.0 GPa or more, and there is a tendency that the higher the acetyl-substitution degree, the higher the elastic modulus of a film that contains cellulose acetate as a main component. The elastic modulus of a film that contains the styrene-based resin, which was exemplified as a main component of the A layer, as a main component is about 2.0 GPa. If cellulose acylate of which the acetyl-substitution degree is 2.6 or higher is used, a C layer that has an elastic modulus higher than the elastic modulus of the A layer that contains the above resin as a main component can be formed.

In addition, in view of improving handleability, a film thickness d and the elastic modulus E′ (GPa) of the C layer preferably satisfy the following formula which is 30≦E′×d≦300, and more preferably satisfy the following formula which is 40≦E′×d≦250.

The thickness of the C layer is not particularly limited. In order to improve handleability of the multilayer film, the thickness is preferably 10 μm or more, and more preferably 20 μm or more. On the other hand, in view of discarding the material of the laminate layer, the thinner the C layer, the more preferable. For example, the thickness is preferably 40 μm or less, and more preferably 35 μm or less.

(Thickness of Multilayer Film)

There is no particular limitation on the total film thickness of the multilayer film including the optical film and the C layer. In view of improving handleability, the total thickness is preferably from 20 μm to 200 μm, more preferably from 20 μm to 180 μm, particularly preferably from 30 μm to 150 μm, and most preferably from 40 μm to 100 μm.

(Embodiment of Multilayer)

An example of the multilayer film of the present invention is a multilayer film having a three-layer structure that has the A layer in the center as well as the B layer and the C layer on the top and bottom of the A layer, as shown in the schematic cross-sectional view of FIG. 2. The C layer may be a layer contributing to the improvement of handleability or a protective layer of the A layer (for example, a protective layer for preventing dirt or dust from being attached onto the surface of the A layer, or a protective layer for preventing scratching). Alternatively, the C layer may be a layer having both functions. As described above, when the optical film is practically used, the C layer may be peeled from the optical film. Moreover, according to purposes, the C layer may be provided together with the optical film for these purposes. The C layer may be formed simultaneously with the A layer by co-casting, or formed by separately pasting a film to be the C layer after the A layer is formed.

As described above, the C layer may be peeled from the multilayer film such that the multilayer film can be used in the form of the optical film. On the surface of the A layer that is exposed due to peeling of the C layer, an adhesive layer may be formed by coating or the like, as described in the schematic cross-sectional view as an example shown in FIG. 3. The adhesive layer is used for pasting other members (for example, a polarizer, a retardation film, or a liquid crystal cell) to the A layer. When the optical film is stored or transported before use, the adhesive surface may be protected by laminating a peeling film on the surface of the adhesive layer.

(Film Width)

The width of the multilayer film of the present invention is preferably 400 mm to 2,500 mm, more preferably 1,000 mm or more, particularly preferably 1,500 mm or more, and more particularly preferably 1,800 mm or more.

(Film Length)

The multilayer film of the present invention may have a long shape manufactured consecutively, or a roll shape formed by the long shaped film wound in a roll shape. Moreover, the multilayer film may have a shape suitable for practical use, for example, a shape cut into a rectangle or the like.

Next, materials and methods usable for forming the C layer of the multilayer film of the present invention will be described in detail.

(C Layer)

The material used for forming the C layer is not particularly limited, and can be selected from various polymer materials according to purposes. It is preferable that the materials be selected from thermoplastic resins. Any types of materials can be used as long as the materials can form the C layer by the solution film-forming method. A cellulose ester is a polymer material that makes it possible to form a film by using a solution, and preferable as a main component of the C layer. In addition, the interlayer peeling force between the cellulose ester and the A layer is within the above range, and the cellulose ester can form the C layer having a high elastic modulus. Therefore, the cellulose ester is preferable in use as a transfer material for transferring the optical film, or in the embodiment in which the A layer is a thin layer.

Hereinafter, an embodiment using the cellulose ester as a main component of the C layer will be described in detail, but the main component of the C layer is not limited to the cellulose ester. When the C layer is not used as an optical member, a material or formulation can also be selected which exhibits an appropriate adhesive force to contribute to the improvement of handleability for each step in a step of manufacturing a film or in a step of mounting the film on optical members such as a polarizing plate, and can be easily peeled from the A layer in the following steps.

<Cellulose Ester>

The cellulose ester usable for forming the C layer is a material in which at least a portion of OH groups in a cellulose molecule as a raw material has been substituted with an ester group. The cellulose as a raw material include cotton linters, wood pulp (broad-leaved tree pulp or needle-leaved tree pulp), and the like, and cellulose acylate obtained from any type of raw material cellulose can be used. In some cases, the cellulose can be used by being mixed. These raw material celluloses are disclosed in detail in, for example, Marusawa, Uda, “Plastic material course (17), cellulose-based resin”, Nikkan Kogyo Shimbun (1970) or the technical report published by the Japan Institute of Invention and Innovation, publication No. 2001-1745 (pp 7-8), and these celluloses can be used.

The cellulose ester is preferably an aliphatic ester, that is, preferably has an aliphatic acyl group. Examples of the aliphatic acyl group include an acetyl group, a propynyl group, and a butynyl group. Examples of usable cellulose esters include cellulose acetate, cellulose acetate propionate, cellulose acetate butyrate, cellulose acetate benzoate, cellulose propionate, cellulose butyrate, and the like. Among these, cellulose acetate and cellulose acetate propionate are more preferable, and cellulose acetate is even more preferable. It is preferable to use cellulose acetate having a substitution degree of an acetyl group of 2.6 to 2.95 (more preferably 2.7 to 2.91), since by using such a cellulose acetate, the interlayer peeling force between the C layer and the A layer containing the acrylic resin, styrene-based resin, or polyester-based resin as a main component falls in the above range, and the B layer having a strong elastic force can be formed by the solution film-forming method.

In addition, the substitution degree of an acetyl group or the substitution degree of another acyl group can be obtained by the method specified by ASTM-D817-96.

The weight average molecular weight (Mw) of the cellulose ester used in the present invention is preferably 75,000 or more, more preferably in a range of from 75,000 to 300,000, even more preferably in a range of from 100,000 to 240,000, and particularly preferably 160,000 to 240,000, in view of the solution film-forming properties and the like.

For the purpose of controlling the level of various physical properties such as mechanical characteristics or optical properties and improving durability, the C layer may contain one or more kinds of additives such as a plasticizer, inorganic fine particles (referred to as a matting agent in some cases), and an ultraviolet absorber, in addition to the above main components. Likewise, the C layer described later may also contain one or more kinds of additives.

In addition, the C layer may be formed simultaneously with the A layer by co-casting. The C layer may also be formed by separately pasting a film or the like to be the C layer, after the A layer or the optical film is manufactured. As the film that can be pasted, various general purpose films such as a cellulose ester film, a polycarbonate film, a polyethylene terephthalate film, a polyimide film, a polymer liquid crystal film, and a cyclic olefin film can be used.

(Adhesive Layer)

An adhesive layer may be formed on the surface of the optical film that is obtained by peeling the C layer from the multilayer film. The adhesive layer is used for, for example, pasting other members (for example, a polarizer, other retardation films, a film for protecting a polarizing plate, or liquid crystal cell) to the optical film. The adhesive layer can be formed on, for example, the surface of the A layer that is exposed due to peeling of the C layer Moreover, when the optical film is stored or transported before use, the adhesive surface may be protected by laminating a peeling film on the surface of the adhesive layer.

There is no particular limitation on the materials usable for forming the adhesive layer. Specifically, the adhesive disclosed in JP2011-37140A or the like can be used. In addition, when the A layer contains a cellulose acylate-based resin as a main component, the adhesive layer may be pasted using a PVA glue by the method used in the related art, so long as the glue does not influence the performance of the A layer.

[Manufacturing Method of Multilayer Film]

The present invention relates to a manufacturing method of the multilayer film. An example of the manufacturing method of the multilayer film is a manufacturing method of a multilayer film that includes manufacturing a multilayer structure including the A layer and the C layer by a solution co-casting method, and forming the B layer on the surface of the A layer of the multilayer structure by coating.

If the C layer is formed together with the A layer by the solution co-casting method, deterioration of handleability that is caused by thinning of the A layer in forming the film can be reduced. In addition, insufficient strength of the B layer, which is formed by coating and functions as a support, caused by thinning of the A layer can be made up.

The solution co-casting used in the manufacturing method is not particularly limited, and can be performed by employing various instruments, conditions, and the like that have been used for solution co-casting in the related art.

<Preparation of Dope>

In the solution co-casting method, solutions (dopes) for forming the respective layers are prepared. The dope can be prepared by dissolving the material for forming each layer in an organic solvent. Examples of the materials for forming the A layer and the C layer are as described above. In preparing the solution (dope), the dissolution method is implemented by a room temperature dissolution method, a cooling dissolution method, or a high temperature dissolution method, or by a combination of these methods. Regarding these methods, the methods of preparing a cellulose acylate solution that are disclosed in, for example, JP1993-163301A (JP-H05-163301A), JP1986-106628A (JP-S61-106628A), JP1983-127737A (JP-S58-127737A), JP1997-95544A (JP-H09-95544A), JP1998-95854A (HP-H10-95854A), JP1998-45950A (JP-H10-45950A), JP2000-53784A, JP1999-322946A (JP-H11-322946A), JP1999-322947A (JP-H 11-322947A), JP1990-276830A (JP-H02-276830A), JP2000-273239A, JP1999-71463A (JP-H11-71463A), JP1992-259511A (JP-H04-259511A), JP2000-273184A, JP1999-323017A (JP-H11-323017A), and JP1999-302388A (JP-H11-302388A) can be referred to. Details of the dissolution method, particularly, the dossolution method regarding non-chlorine-based solvents can be performed by the method disclosed in detail in Publication No. 2001-1745, pp 22-25 described above. In addition, the dope solution generally undergoes concentration and filtration, and details thereof are also disclosed in Publication No. 2001-1745, p. 25 as described above. Moreover, when the material is dissolved at a high temperature, the temperature is mostly equal to or higher than a boiling point of the organic solvent used. In this case, the material is dissolved in a pressurized state.

(Organic Solvent)

There is no particular limitation on the organic solvent used for preparing a dope used for forming each layer A suitable organic solvent can be selected according to the solubility or the like of the material for forming a film, from various organic solvents such as chlorides of lower aliphatic hydrocarbons, lower aliphatic alcohols, ketones having 3 to 12 carbon atoms, esters having 3 to 12 carbon atoms, ethers having 3 to 12 carbon atoms, aliphatic hydrocarbons having 5 to 8 carbon atoms, aromatic hydrocarbons having 6 to 12 carbon atoms, and fluoroalcohols (for example, the compounds disclosed in Paragraph [0020] of JP1996-143709A (JP-H08-143709A), Paragraph [0037] of JP1999-60807A (JP-H11-60807A), and the like).

The solvents may be used alone or used in combination. However, in order to impart surface shape stability, it is preferable to mix a good solvent with a poor solvent and use the resultant. More preferably, a mixing ratio of a good solvent:a poor solvent is 60% by mass to 99% by mass:40% by mass to 1% by mass. In the present invention, a good solvent refers to a solvent that dissolves a resin used by itself, and a poor solvent refers to a solvent that causes a resin used to be swollen or does not dissolve the resin by itself. Examples of the good solvent include organic halogen compounds such as methylene chloride and dioxolanes. In addition, as the poor solvent, for example, methanol, ethanol, n-butanol, cyclohexane, and the like are preferably used.

The proportion of an alcohol in the organic solvent is preferably 10% by mass to 50% by mass of the whole organic solvent, since the time required for the formed film to be dried on a support (casting substrate) is shortened, and the film can be rapidly peeled and dried in this proportion. The proportion is more preferably 15% by mass to 30% by mass.

(Solid Concentration of Dope)

The materials for forming the respective layers are preferably dissolved in an organic solvent so as to yield a solid concentration (sum of components that are solids after being dried) of 10% by mass to 60% by mass. The solid concentration is more preferably 10% by mass to 50% by mass. When a cellulose ester is used as a main component, the cellulose ester is preferably dissolved at a solid concentration of 10% by mass to 30% by mass, more preferably dissolved at a solid concentration of 15% by mass to 25% by mass, and most preferably dissolved at a solid concentration of 18% by mass to 20% by mass. Here, depending on purposes, sometimes the solid concentration of a dope is preferably more than 20% by mass and equal to or less than 22% by mass, since the content of an organic solvent can be reduced and the time required for drying can be shortened in this range. As a method of adjusting the solid concentration to be in this range, the solid concentration may be adjusted to be a predetermined value at the stage of dissolution. Alternatively, a solution with a low concentration (for example, 9% by mass to 14% by mass) may be prepared in advance, and then the concentration be adjusted to prepare a solution with a high concentration in a step of concentration. In addition, a high-concentration solution that includes a material for forming a light transmissive substrate may be prepared in advance, and then various additives may be added thereto to prepare a solution with a predetermined low concentration.

Regarding the composition of the polymer material as a main component in a dope, for example, a proportion of a cellulose ester in a dope containing the cellulose ester is preferably 50% by mass to 100% by mass, more preferably 70% by mass to 100% by mass, and most preferably 80% by mass to 100% by mass, in view of achieving support releasing properties, interfacial adhesion properties, and low curl. In addition, a proportion of an acrylic resin in a dope containing the acrylic resin is preferably 30% by mass to 100% by mass, more preferably 50% by mass to 100% by mass, and most preferably 70% by mass to 100% by mass.

On the other hand, in order to obtain a film having an excellent surface shape by means of forming the film by co-casting, a difference in the solid concentration between dopes for forming the respective layers is preferably within 10% by mass, and more preferably within 5% by mass.

Particularly, in a dope for forming the B layer, the solid concentration is preferably 16% by mass to 30% by mass, and a difference in the solid concentration between dopes for forming the respective layers is preferably within 10% by mass.

(Casting)

The above method may include a step of laminating and casting a dope for the A layer (hereinafter, referred to as a dope A in some cases) and a dope for the C layer (hereinafter, referred to as a dope C in some cases) on a casting support by a co-casting method. Either the dope A or the dope C may contact the support side.

Each dope cast onto the support is dried on the support, and the solvent is evaporated, whereby a film is formed. Herein, though not particularly limited, the support is preferably a drum or a band. The surface of the support preferably has undergone mirror finishing in advance. The method of casting and drying in a solvent casting method are disclosed in the respective gazettes including U.S. Pat. Nos. 2,336,310, 2,367,603, 2,492,078, 2,492,977, 2,492,978, 2,607,704, 2,739,069, and 2,739,070, UK Patent Nos. 640731 and 736892, JP1970-4554B (JP-S45-4554B), JP1974-5614B (JP-S49-5614B), JP1985-176834A (JP-S60-176834A), JP1985-203430A (JP-S60-203430A), and JP1987-115035A (JP-S62-115035A).

In the present invention, two or more kinds of dopes are cast onto the casting support to form a film. In the manufacturing method of a film of the present invention, known co-casting methods can be used without particular limitation, in addition to the above method. For example, a film may be formed while layers are being laminated on each other by casting dope solutions respectively from a plurality of casting ports arranged in the movement direction of a metal support at intervals. For example, the methods disclosed in the respective gazettes including JP1986-158414A (JP-S61-158414A), JP1989-122419A (JP-H01-122419A), and JP1999-198285A (JP-H11-198285A) are applicable. In addition, a film can also be formed by casting the dope solutions from two casting ports, and for example, this can be performed by the methods disclosed in the respective gazettes including JP1985-27562B (JP-S60-27562B), JP1986-94724A (JP-S61-94724A), JP-1986-947245A (JP-S61-947245A), JP1986-104813A (JP-S61-104813A), JP1986-158413A (JP-S61-158413A), and JP1994-134933A (JP-H06-134933A).

<Drying Step>

The cast dope is dried on a drum or a band. A web, which is peeled in a peeling position located just before a position where the drum or the belt makes one revolution, is transported by a method in which the web alternately passes through a group of rolls arranged in zigzags, or by a method in which both ends of the peeled web are gripped by clips or the like such that the web is transported in a non-contact manner. Drying is performed by a method of blowing air of a predetermined temperature to both surfaces of the web (film) in transporting, or by a method using heating means such as microwaves. If the web is dried too rapidly, there is a concern that planarity of the formed film will deteriorate. Accordingly, at the initial stage of drying, drying is preferably performed at a temperature of such a degree that the solvent is not foamed, and after drying has proceeded, the web is preferably dried at a high temperature. In the drying step performed after the film is peeled from a support, due to the evaporation of the solvent, the film tends to contract in a longitudinal direction or a width direction. The higher the drying temperature is, the more the contraction becomes serious. In order to allow the completed film to have excellent planarity, it is preferable to dry the film while inhibiting the contraction as much as possible. In this respect, a method (tenter method) of drying the film while holding both ends of the web in the width direction by using clips or pins throughout the entire drying step or in a partial step, as described in, for example, JP1987-46625A (JP-S62-46625A), is preferable. A drying temperature in the above drying step is preferably 100° C. to 145° C. The drying time, the amount of air for drying, and the drying time vary with the type of the solvents to be used, and may be appropriately selected according to the type and combination of the solvents used.

The film is preferably peeled from the support after the dope cast to form a multilayer is dried on the support.

<Post Treatment Step>

After the film is formed on the support, a single layer film or a multilayer film is peeled from the support. A stretching treatment, a contraction treatment, a heating treatment, a treatment using heated steam (treatment for blowing steam), a surface treatment, or the like may be performed on the peeled multilayer film. The stretching treatment or the contraction treatment may be performed for adjusting the optical characteristics of the A layer to be in a predetermined range. In addition, the surface treatment (an acid treatment, an alkali treatment, a plasma treatment, a corona treatment, or the like) may be performed for improving adhesiveness between the A layer and other layers.

[Manufacturing Method of Optical Film]

The present invention also relates to a manufacturing method of the optical film of the present invention that uses the multilayer film of the present invention. Specifically, an example of the manufacturing method of the optical film of the present invention is a manufacturing method of an optical film that includes preparing the multilayer film of the present invention, and peeling the C layer from the multilayer film.

It is preferable to form an adhesive layer on the surface of the A layer that is exposed due to peeling of the C layer. Examples of materials usable for forming the adhesive layer include the same materials as described above. By using the adhesive layer formed on the surface of the A layer, other films (for example, a polarizing film or a retardation film), a liquid crystal cell, or the like can be pasted.

The peeled C layer may be discarded as is or used for other purposes. For example, an embodiment may be employed in which the peeled C layer is cut or ground, and the polymer material as a main component of the B layer is collected, such that these are reused for preparing a dope for forming the C layer of the multilayer film of the present invention, and the dope is cast by solution co-casting together with a dope for forming the A layer so as to manufacture the multilayer film of the present invention. By collecting the polymer material for the C layer and reusing it, the manufacture cost and the amount of waste can be reduced.

[Polarizing Plate]

The present invention also relates to a polarizing plate that includes at least the optical film of the present invention (also including the optical film of the present invention that is transferred from the multilayer film of the present invention) and a polarizing film. The optical film can be used as a protective film in a polarizing plate that includes a polarizing film and the protective film that is disposed in at least one side of the polarizing film. In addition, other films (a protective film, a retardation film, and the like) may be disposed between the optical film and the polarizing film.

In addition, in an embodiment in which a protective film is disposed on both surfaces of a polarizing film, the optical film can also be used as a protective film for one surface in the constitution of the polarizing plate.

As the polarizing film, there are an iodine-based polarizing film, a dye-based polarizing film using a dichroic dye, and a polyene-based polarizing film. The iodine-based polarizing film and the dye-based polarizing film can be manufactured using a polyvinyl alcohol-based film in general.

The thickness of a polarizing film is not particularly limited. However, the smaller the thickness of the polarizing film is, the thinner the polarizing plate and the liquid crystal display device including the polarizing plate can be. In this respect, the thickness of the polarizing film is preferably 10 μm or less. An optical path in the polarizing film needs to be greater than a wavelength of light, so the lower limit of the thickness of the polarizing film is 0.7 μm or more, practically 1 μm or more, and preferably greater than 3 μm in general.

[Liquid Crystal Display Device]

The present invention also relates to a liquid crystal display device including at least the optical film of the present invention (including the optical film of the present invention that is transferred from the multilayer film of the present invention) or the polarizing plate of the present invention described above. The alignment mode of the liquid crystal display device is not particularly limited. However, it is preferable that the liquid crystal display device use a horizontal alignment mode (IPS mode and FFS mode). The optical film of the present invention that includes the A layer and B layer is useful as a viewing angle compensation film of a liquid crystal display device in IPS mode and FFS mode.

The optical film of the present invention may be disposed between a liquid crystal cell and a polarizing film at a viewing side, or disposed between a liquid crystal cell and a polarizing film at a backlight side. For example, in an embodiment of the horizontal alignment mode, the optical film of the present invention is preferably disposed between a liquid crystal cell and a polarizing film at a viewing side in the IPS mode, and preferably disposed between a liquid crystal cell and a polarizing film at a backlight side in the FFS mode.

In the present specification, each of Re (λ) and Rth (λ) represents in-plane retardation at a wavelength λ and retardation in the thickness direction respectively. Re (λ) is measured by causing light having a wavelength of λ nm to enter in the normal direction of the film in KOBRA 21 ADH or WR (manufactured by Oji Scientific Instruments). In selecting the wavelength λ nm for the measurement, wavelength selection filters can be switched according to the manual, or the measurement value can be converted using a program or the like to measure the wavelength.

When a film to be measured is indicated as a uniaxial or biaxial refractive index ellipsoid, Rth (λ) is calculated by the following method. To measure Rth (λ), light having a wavelength λ nm is caused to enter at a normal direction to the film where an in-plane slow axis (determined by KOBRA 21 ADH or WR) is regarded as an inclination axis (rotation axis) (when there is no slow axis, any direction within the plane of the film is regarded as a rotation axis), from the respective inclined directions in steps of 10° up to the position at one side inclined 500 from the normal direction, so as to measure Re (λ) at 6 points. Based on the values of retardation measured, values of the average refractive index assumed, and the value of film thickness input, Rth (λ) is calculated by KOBRA 21 ADH or WR.

In the above measurement, if the film has a direction in which the value of retardation becomes zero at a certain inclination angle when an in-plane slow axis from the normal direction is regarded as a rotation angle, the sign of the value of retardation at an inclination angle larger than the above inclination angle is changed to be negative, and then Rth (λ) is calculated by KOBRA 21 ADH or WR.

In addition, the value of retardation is measured from any two inclined directions, by using the slow axis as an inclination axis (rotation axis) (when there is no slow axis, any direction within the plane of the film is regarded as a rotation axis), and based on the value, the value of the average refractive index assumed, and the value of film thickness input, Rth (λ) can be calculated by the following Formulae (1) and (2).

$$[ Formula 1 ]$$

$$Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}}$$

Rth={(nx+ny)/2−nz}×d Formula (2)

In the above formulae, Re (θ) represents a value of retardation in a direction inclined at an angle θ from the normal direction, nx represents a refractive index in a slow axis direction within the plane, ny represents a refractive index in a direction orthogonal to nx within the plane, nz represents a refractive index in a direction orthogonal to nx and ny, and d represents a film thickness.

When the film to be measured cannot be expressed as a uniaxial or biaxial refractive index ellipsoid, that is, when the film does not have a so-called optic axis, Rth (λ) is calculated by the following method.

To measure Rth (λ), light having a wavelength λ nm is caused to enter at a normal direction to a film where an in-plane slow axis (determined by KOBRA 21 ADH or WR) is regarded as an inclination axis (rotation axis), from the respective inclined directions in steps of 10° up to the position inclined −50° to +50° from the normal direction, so as to measure Re (λ) at 11 points. Based on the values of retardation measured, values of the average refractive index assumed, and the value of film thickness input, Rth (λ) is calculated by KOBRA 21 ADH or WR.

In the above measurement, as the value of the average refractive index assumed, values described in Polymer Handbook (JOHN WILEY & SONS, INC) and catalogs of various optical films can be used. When the value of the average refractive index is not known, the value can be measured using an Abbe's refractometer Examples of the values of the average refractive index of main optical films are as follows: cellulose acylate (1.48), a cyclo-olefin polymer (1.52), polycarbonate (1.59), polymethyl methacrylate (1.49), polystyrene (1.59). When these values of the average refractive index assumed and the film thickness are input into KOBRA 21 ADH or WR, the instrument calculates nx, ny, and nz. From the calculated nx, ny, and nz, Nz=(nx−nz)/(nx−ny) is further calculated.

In the present specification, the wavelength for measuring a refractive index is set to 550 nm unless otherwise specified.

### EXAMPLES

Hereinafter, the characteristics of the present invention will be described in more detail based on examples.

The materials, amount used, proportion, details of treatment, treatment procedure, and the like shown in the following examples can be appropriately changed as long as these do not depart from the object of the present invention. Accordingly, the scope of the present invention is not limited to the specific examples shown below.

In addition, a “part” is based on mass unless otherwise specified.

[Measurement Method]

<Three-Dimensional Refractive Index>

A three-dimensional refractive index was measured by ellipsometry (model M2000V manufactured by J. A. Woollam Co., Inc.) at a wavelength of 550 nm.

1. Manufacture and Evaluation of Optical Film and Multilayer Film

(1) Preparation of Dope

<Preparation of Dope A>

Dopes A were respectively prepared using the respective polymer materials described in the following tables. As a solvent, ethylene chloride was used. However, in some examples, a mixed solvent obtained by mixing methanol, n-butanol, and the like together was used according to the solubility of the material. Moreover, any of the dopes was prepared at a solid concentration of 20% by mass.

In addition, the main component of each dope is described below the tables.

A main component P0 of the A layer of film No. 1 was cellulose acetate having an oxidation degree of 60.7% to 61.1%. The A layer of film No. 1 was manufactured using a dope A having the following composition.

(Composition of Dope A)

| | |
|---|---|
| Cellulose acetate having an oxidation degree of | 100 parts by mass |
| 60.7% to 61.1% | |
| Triphenyl phosphate (plasticizer) | 7.8 parts by mass |
| Biphenyl diphenyl phosphate (plasticizer) | 3.9 parts by mass |
| Methylene chloride (first solvent) | 336 parts by mass |
| Methanol (second solvent) | 29 parts by mass |
| 1-Butanol (third solvent) | 11 parts by mass |

16 parts by mass of the following retardation-raising agent (A), 92 parts by mass of methylene chloride, and 8 parts by mass of methanol were put in another mixing tank, followed by stirring under heating, thereby preparing a solution of a retardation-raising agent. 474 parts by mass of a cellulose acetate solution was mixed with 25 parts by mass of the solution of a retardation-raising agent, and the mixture was stirred sufficiently to prepare a dope. The amount of the retardation-raising agent added was 6.0 parts by mass based on 100 parts by mass of cellulose acetate.

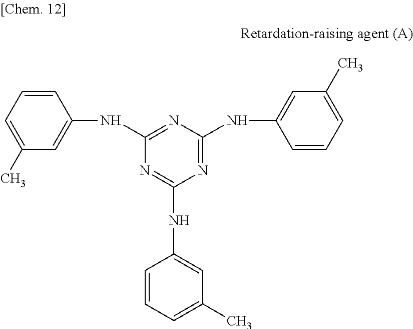 [SMILES: Cc1cccc(Nc2nc(Nc3cccc(C)c3)nc(Nc3cccc(C)c3)n2)c1]

The obtained dope was cast using a band stretching machine to form the A layer for film No. 1. After the film surface temperature on the band became 40° C., the A layer was dried for 1 minute and then peeled off. Thereafter, the A layer was stretched by 15% in the width direction by using a tenter in dry air at 140° C. Subsequently, the A layer was dried for 20 minutes with dry air at 135° C., thereby manufacturing the A layer for film No. 1 that is a cellulose acetate film in which an amount of a residual solvent was 0.3% by mass.

A main component P1 of the A layer for film Nos. 2 to 21 was a cellulose acylate resin (having a benzoyl substitution degree of 1.6, an acetyl substitution degree of 1.1, and a total acyl substitution degree of 2.7) having an aromatic group including benzoyl and acetyl. The cellulose acylate resin was manufactured by saponifying cellulose and then acylating the resultant. The saponification and acylation were performed with reference to Paragraphs [0121] to [01240] in JP2008-163193A.

<Preparation of Dope C>

In the following tables, for the examples of the multilayer film, dopes C for the C layer were respectively prepared using polymer materials described in the following tables. As a solvent, methylene chloride was used.

(2) Forming Film by Solution Casting

Each dope A was cast alone onto a support, thereby manufacturing single-layered optical films respectively. Alternatively, each dope A was combined with the dope C as described in the following table, and the mixture was co-cast onto a support, thereby preparing a multilayer structure including the A layer and the C layer. As the support, a metal support was used. The dope was dried with dry air to form a film on the support, and the obtained respective multilayer films were peeled from the support.

(3) Stretching

For some examples shown in the following tables, after the film was peeled from the support, a stretching treatment was performed by stretching the film in a transport direction by using a difference in circumferential speed between rolls in a case of free-end-uniaxial stretching, or by stretching the film by using a tenter in a case of fixed-end-uniaxial stretching. Stretching conditions of the film having undergone the stretching treatment will be described below respectively. The films not described below were not subjected to the stretching treatment.

Film No. 2: fixed-end-uniaxial stretching treatment; temperature 198° C., speed 30%/min, stretch rate 90%

Film No. 3: fixed-end-uniaxial stretching; temperature 204° C., speed 30%/min, stretch rate 55%

Film No. 4: fixed-end-uniaxial stretching; temperature 204° C., speed 30%/min, stretch rate 45%

Film No. 5: fixed-end-uniaxial stretching; temperature 204° C., speed 30%/min, stretch rate 40%

Film No. 6: fixed-end-uniaxial stretching; temperature 204° C., speed 30%/min, stretch rate 35%

Film No. 7: fixed-end-uniaxial stretching; temperature 199° C., speed 30%/min, stretch rate 70%

Film Nos. 12 and 13: free-end-uniaxial stretching; temperature 199° C., speed 30%/min, stretch rate 40%

Film No. 14: fixed-end-uniaxial stretching; temperature 204° C., speed 30%/min, stretch rate 70%

Film Nos. 8, 10, 11, and 15 to 21: fixed-end-uniaxial stretching; temperature 204° C., speed 30%/min, stretch rate 70%

Film No. 22: free-end-uniaxial stretching; temperature 130° C., speed 30%/min, stretch rate 80%

Film No. 23: free-end-uniaxial stretching; temperature 140° C., speed 30%/min, stretch rate 80%

Film Nos. 24 and 29: free-end-uniaxial stretching; temperature 120° C., speed 30%/min, stretch rate 30%

Film No. 25: fixed-end-uniaxial stretching; temperature 120° C., speed 30%/min, stretch rate 30%

Film No. 26: fixed-end-uniaxial stretching; temperature 120° C., speed 30%/min, stretch rate 25%

Film No. 27: fixed-end-uniaxial stretching; temperature 125° C., speed 30%/min, stretch rate 35%

Film No. 28: fixed-end-uniaxial stretching; temperature 118° C., speed 30%/min, stretch rate 30%

(4) Formation of B layer

(4)-1 Formation of B Layer Including Discotic Liquid Crystalline Composition:

(Formation of Alignment Layer)

By using a wire bar coater, a coating liquid for an alignment layer that has the following composition was coated onto the surface of the A layer of the respective film prepared as above, and the resultant was dried to form an alignment layer.

TABLE 1
Composition of coating liquid for alignment layer

| | | |
|---|---|---|
| Modified polyvinyl | 10 | parts by mass |
| alcohol described below | | |
| Water | 371 | parts by mass |
| Methanol | 119 | parts by mass |
| Glutaraldehyde | 0.5 | parts by mass |

(crosslinking agent)

[Chem. 13]
Modified polyvinyl alcohol

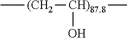

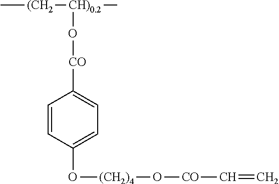

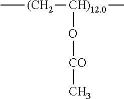

41.01 g of the disk-like liquid crystalline compound shown below, 4.06 g of ethylene oxide-modified trimethylolpropane triacrylate (V#360, manufactured by OSAKA ORGANIC CHEMICAL INDUSTRY LTD.), 1.85 g of 1,3,5-triazine compound (II-1), 1.35 g of photopolymerization initiator (Irgacure 907 manufactured by Ciba-Geigy K. K.), and 0.45 g of a sensitizer (Kayacure DETX manufactured by NIPPON KAYAKU Co., Ltd.) were dissolved in 102 g of methyl ethyl ketone to prepare a coating liquid.

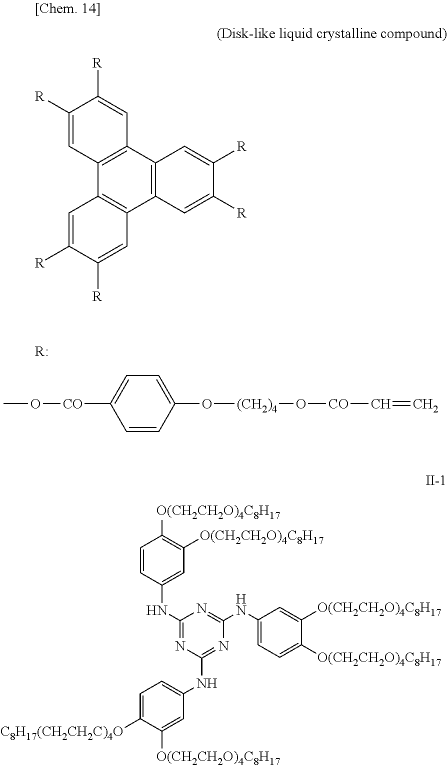

The coating liquid was coated onto alignment layer by using a #4 wire bar. The resultant was pasted to a metal frame and heated for 30 seconds in a constant-temperature bath at 120° C., thereby aligning the disk-like liquid crystalline compound. In addition, the liquid crystal crystalline compound was irradiated with UV rays of 2 J by using a high-pressure mercury lamp at 120° C. so as to be polymerized, and the aligned state was checked. As a result, it was found that the liquid crystalline compound was aligned horizontally. Thereafter, the compound was left to be cooled to room temperature. In this manner, a retardation layer (B layer) was formed on each film.

In addition, the B layer formed as above was heated at 80° C., irradiated or not irradiated with UV rays of 2 J, and adjusted in terms of the film thickness, thereby forming the respective B layers having various optical characteristics as shown in the following tables. In the tables, an example in which the words “disk-like liquid crystal” are described in the column of “material” of the B layer is the B layer which is formed using the discotic liquid crystal composition in the same manner as above. The thickness and the optical characteristics of the respective B layers are shown in the following tables.

(4)-2 Formation of B Layer Including Polymer Material:

By respectively using the polymer materials for B layer described in the following tables, the B layer was formed.

The B layer for film No. 10 was manufactured by forming the P1 (a cellulose acylate resin having an aromatic group that has benzoyl and acetyl; a benzoyl substitution degree of 1.6, an acetyl substitution degree of 1.1, and a total acyl substitution degree of 2.7) into a film by using a solution casting method, and then performing a thermal treatment for 5 minutes at 200° C. and a fixed-end-uniaxial stretching treatment (temperature 199° C., speed 30%/min, stretch rate 10%). The film for the B layer prepared in this manner was laminated on the A layer.

The B layer for film No. 11 was manufactured in the same manner as above, except that after the film for the B layer of film No. 10 was formed in the same manner as above, a thermal treatment was performed for 5 minutes at 200° C., but a stretching treatment was not performed. The film for the B layer prepared in this manner was laminated on the A layer.

The B layer of film No. 20 was formed by coating, in the same manner as in Reference Example 5 disclosed in JP2009-163210A.

The B layer of film No. 21 was formed by preparing a coating liquid by dissolving the polycarbonate disclosed in Paragraphs [0134] to [0143] in JP2009-163210A in methylene chloride, coating the coating liquid onto the surface of a film for the A layer by using an applicator, and drying the resultant.

2. Evaluation of Films

The respective films obtained were measured as described above, in terms of characteristics of the respective layers and the characteristics of the films as a multilayer optical film including the A layer and B layer. The results are shown in the following tables.

In addition, transport properties of the obtained respective films during formation of the film were evaluated respectively based on the following criteria.

Transport properties:
A: The film could be transported without any problems.
B: Though slightly twisted or wrinkled when transported, the film could be transported.
C: The film failed to be transported (the film was broken during transport).
   The results are shown in the following tables.

3. Mounting Evaluation

(1) Formation of Adhesive Layer

By using the following adhesive composition, an adhesive layer was formed on the surface of the respective A layers of the films manufactured as above. In addition, film No. 29 was a three-layer structure including the C layer/A layer/B layer, and the adhesive layer was formed on the surface of the A layer that was exposed due to peeling of the C layer. The C layer was easily peeled, and breakage or damage was not confirmed.

91 parts by mass of butyl acrylate, 3 parts by mass of acrylic acid, 1.5 parts by mass of N-(2-hydroxyethyl)acrylamide, 4.5 parts by mass of DMAA (N,N-dimethylacrylamide), 0.2 parts by mass of benzoyl peroxide, and 200 parts by mass of toluene were put in a four-necked flask provided with a cooling tube, a stirring blade, and a thermometer, and the flask was sufficiently purged with nitrogen. Thereafter, the mixture was reacted for 8 hours at about 60° C. while being stirred under a nitrogen gas flow, thereby obtaining a solution of an acrylic copolymer having a weight average molecular weight of 1,800,000 (in terms of GPC polystyrene). An isocyanate-based crosslinking agent (Coronate L manufactured by NIPPON POLYURETHANE INDUSTRY CO., LTD.) was added thereto in an amount of 0.5 parts by mass in terms of the solid content, based on 100 parts by mass of the solid of the solution of an acrylic copolymer, thereby preparing an adhesive solution.

The obtained adhesive solution was coated on a separator including a polyester film (thickness 35 μm) having undergone a release treatment by a reverse roll coating method, such that the thickness of the adhesive layer after drying became 20 μm. The resultant was heated for 3 minutes at 155° C., and the solvent was volatilized, thereby obtaining an adhesive layer. The adhesive layer was laminated on the surface of the respective A layers of the films manufactured as above, thereby preparing adhesive-attached films respectively.

(2) Preparation of Polarizing Plate

As a polarizing film, a polyvinyl alcohol-based polarizing film (thickness of 8 μm) dyed with iodine was prepared.

The above respective film was pasted onto one surface of the polarizing film by using a 3% aqueous solution of PVA (manufactured by KURARAY CO., LTD., PVA-117H), such that the in-plane slow axis of the respective film prepared as above be in parallel with the absorption axis of the polarizing film. At this time, a configuration was employed in which the surface of the A layer was pasted onto the surface of the PVA polarizing film, and the B layer was laminated on the other surface of the A layer. In addition, a commercially available cellulose acetate film was pasted onto the other surface of the polarizing film, by using the above adhesive. In this manner, the respective polarizing plates were prepared.

As a polarizing plate used by being combined with the respective polarizing plate manufactured as above, a polarizing plate c was prepared which was obtained by pasting Z-TAC (a cellulose acetate film showing a low degree of retardation manufactured by Fujifilm Corporation) onto one surface of the polarizing film and pasting a commercially available cellulose acetate film onto the other surface.

(3) Preparation of Liquid Crystal Cell

A liquid crystal panel was taken out of a 32 inch liquid crystal display device (Liquid-crystal display television, trade name “Wooo” manufactured by Hitachi, Ltd., model No. W32-L7000) including a liquid crystal cell of IPS mode. All optical films arranged on the top and bottom of the liquid crystal cell were removed, and the glass surface of the front and rear surfaces of the liquid crystal cell was washed.

(4) Preparation of Liquid Crystal Display Device

The respective polarizing plates prepared above were pasted onto the surface at a display surface side of the above IPS mode liquid crystal cell, and the polarizing plate c was pasted onto the surface at a backlight side, in a manner in which the absorption axes of the plates became orthogonal to each other. In addition, a commercially available cellulose acetate film was pasted to all of the polarizing plates, outside of the plate. In this manner, the IPS mode liquid crystal display devices LCD were prepared respectively.

(5) Evaluation of Liquid Crystal Display Devices

The respective prepared LCDs were allowed to display black, and black luminance (black luminance at a viewing angle) obtained when the screen was observed from an inclined direction (polar angle of 60°) and display unevenness recognized when the screen was observed from a front direction in the state of black display were evaluated respectively based on the following criteria.

### Black Luminance at Viewing Angle:

AA: 1.5 cd/m² or less
A: greater than 1.5 cd/m² and equal to or less than 3.0 cd/m²
B: greater than 3.0 cd/m² and equal to or less than 5.0 cd/m²
C: greater than 5.0 cd/m²
   Display unevenness:
AA: occurrence of unevenness was not recognized.
A: unevenness was caused slightly.
B: unevenness was clearly recognized in a portion.
C: unevenness was recognized in the entire screen.

The results are shown in the following tables.

TABLE 2

| | A layer | | | | | | | B layer | | | | |
|---|---|---|---|---|---|---|---|---|---|---|---|---|
| | | Film | | | | | | | Film | | | |
| | | thickness | | | | Re | Rth | | thickness | Re | Rth | |
| Film No. | Material | μm | nx | ny | nz | nm | nm | Material | μm | nm | nm | C layer |
| 1 | P0 | 1 | — | — | — | — | — | Disk-like | 2.0 | — | — | n/a |
| (Comparative | | | | | | | | liquid | | | | |
| Example) | | | | | | | | crystal | | | | |
| 2 | P1 | 9 | 1.510 | 1.508 | 1.511 | 97 | −95 | Disk-like | 2.0 | 1 | 99 | n/a |
| (Example) | | | | | | | | liquid | | | | |
| | | | | | | | | crystal | | | | |
| 3 | P1 | 26.5 | 1.510 | 1.503 | 1.511 | 102 | −101 | Disk-like | 2.0 | 3 | 96 | n/a |
| (Example) | | | | | | | | liquid | | | | |
| | | | | | | | | crystal | | | | |
| 4 | P1 | 33 | 1.510 | 1.503 | 1.511 | 102 | −99 | Disk-like | 2.0 | 0 | 99 | n/a |
| (Example) | | | | | | | | liquid | | | | |
| | | | | | | | | crystal | | | | |
| 5 | P1 | 36 | 1.510 | 1.503 | 1.511 | 99 | −101 | Disk-like | 2.0 | 0 | 97 | n/a |
| (Example) | | | | | | | | liquid | | | | |
| | | | | | | | | crystal | | | | |
| 6 | P1 | 40 | 1.510 | 1.503 | 1.511 | 97 | −102 | Disk-like | 2.0 | 1 | 98 | n/a |
| (Comparative | | | | | | | | liquid | | | | |
| Example) | | | | | | | | crystal | | | | |

| | Optical film (A layer + B layer) | | | | | LCD evaluation | |
|---|---|---|---|---|---|---|---|
| | Total | | | | Evaluation | Black | |
| | thickness | \|Re\| | \|Rth\| | (\|Re\|/ | of transport | luminance at | Display |
| Film No. | μm | nm | nm | \|Rth\|) + 0.5 | properties | viewing angle | unevenness |
| 1 | 3 | — | — | — | C | — | — |
| (Comparative | | | | | | | |
| Example) | | | | | | | |
| 2 | 11 | 315 | −22 | 0.57 | B | AA | AA |
| (Example) | | | | | | | |
| 3 | 28.5 | 321 | 1 | 0.50 | B | AA | A |
| (Example) | | | | | | | |
| 4 | 35 | 306 | −10 | 0.53 | B | AA | B |
| (Example) | | | | | | | |
| 5 | 38 | 316 | −11 | 0.53 | B | AA | B |
| (Example) | | | | | | | |
| 6 | 42 | 326 | −8 | 0.52 | B | AA | C |
| (Comparative | | | | | | | |
| Example) | | | | | | | |

TABLE 3

| | A layer | | | | | | | B layer | | | | |
|---|---|---|---|---|---|---|---|---|---|---|---|---|
| | | Film | | | | | | | Film | | | |
| | | thickness | | | | Re | Rth | | thickness | Re | Rth | |
| Film No. | Material | μm | nx | ny | nz | nm | nm | Material | μm | nm | nm | C layer |
| 7 | P1 | 20 | 1.510 | 1.508 | 1.511 | 166 | −105 | Disk-like | 2.0 | 2 | 102 | n/a |
| (Example) | | | | | | | | liquid | | | | |
| | | | | | | | | crystal | | | | |
| 8 | P1 | 20 | 1.510 | 1.508 | 1.511 | 101 | −100 | Disk-like | 2.0 | 2 | 99 | n/a |
| (Example) | | | | | | | | liquid | | | | |
| | | | | | | | | crystal | | | | |
| 9 | P1 | 20 | 1.510 | 1.508 | 1.511 | 2 | 103 | Disk-like | 2.0 | 23 | 100 | n/a |
| (Comparative | | | | | | | | liquid | | | | |
| Example) | | | | | | | | crystal | | | | |
| 10 | P1 | 20 | 1.510 | 1.508 | 1.511 | 101 | −99 | P1 | 20.0 | 22 | −99 | n/a |
| (Comparative | | | | | | | | | | | | |
| Example) | | | | | | | | | | | | |
| 11 | P1 | 20 | 1.510 | 1.508 | 1.511 | 102 | −103 | P1 | 20.0 | 22 | −160 | n/a |
| (Comparative | | | | | | | | | | | | |
| Example) | | | | | | | | | | | | |
| 12 | P1 | 20 | 1.510 | 1.508 | 1.511 | 41 | −147 | Disk-like | 5.5 | 1 | 279 | n/a |
| (Example) | | | | | | | | liquid | | | | |
| | | | | | | | | crystal | | | | |
| 13 | P1 | 20 | 1.510 | 1.508 | 1.511 | 41 | −147 | Disk-like | 6.5 | 1 | 320 | n/a |
| (Comparative | | | | | | | | liquid | | | | |
| Example) | | | | | | | | crystal | | | | |
| 14 | P1 | 20 | 1.510 | 1.508 | 1.511 | 105 | −161 | Disk-like | 2.4 | 18 | 120 | n/a |
| (Example) | | | | | | | | liquid | | | | |
| | | | | | | | | crystal | | | | |

| | Optical film ( A layer + B layer) | | | | | LCD evaluation | |
|---|---|---|---|---|---|---|---|
| | Total | | | | Evaluation | Black | |
| | thickness | \|Re\| | \|Rth\| | (\|Re\|/ | of transport | luminance at | Display |
| Film No. | μm | nm | nm | \|Rth\|) + 0.5 | properties | viewing angle | unevenness |
| 7 | 22 | 262 | 67 | 0.76 | B | B | AA |
| (Example) | | | | | | | |
| 8 | 22 | 317 | −6 | 0.52 | B | AA | AA |
| (Example) | | | | | | | |
| 9 | 22 | 20 | 206 | 11.01 | B | C | A |
| (Comparative | | | | | | | |
| Example) | | | | | | | |
| 10 | 40 | 396 | 595 | 2.00 | B | C | B |
| (Comparative | | | | | | | |
| Example) | | | | | | | |
| 11 | 40 | 415 | 814 | 2.48 | B | C | B |
| (Comparative | | | | | | | |
| Example) | | | | | | | |
| 12 | 25.5 | 126 | 7 | 0.56 | B | B | A |
| (Example) | | | | | | | |
| 13 | 26.5 | 41 | 147 | 4.10 | B | C | A |
| (Comparative | | | | | | | |
| Example) | | | | | | | |
| 14 | 22.4 | 375 | 84 | 0.72 | B | B | AA |
| (Example) | | | | | | | |

TABLE 4

| | A layer | | | | | | | B layer | | | | |
|---|---|---|---|---|---|---|---|---|---|---|---|---|
| | | Film | | | | | | | Film | | | |
| | | thickness | | | | Re | Rth | | thickness | Re | Rth | |
| Film No. | material | μm | nx | ny | nz | nm | nm | Material | μm | nm | nm | C layer |
| 15 | P | 20 | 1.510 | 1.508 | 1.511 | 96 | −90 | Disk-like | 1.5 | 1 | 60 | n/a |
| (Example) | | | | | | | | liquid | | | | |
| | | | | | | | | crystal | | | | |
| 16 | P1 | 20 | 1.510 | 1.508 | 1.511 | 97 | −99 | Disk-like | 2.0 | 2 | 97 | n/a |
| (Example) | | | | | | | | liquid | | | | |
| | | | | | | | | crystal | | | | |
| 17 | P1 | 20 | 1.510 | 1.508 | 1.511 | 100 | −101 | Disk-like | 1.2 | 2 | 55 | n/a |
| (Example) | | | | | | | | liquid | | | | |
| | | | | | | | | crystal | | | | |
| 18 | P1 | 20 | 1.510 | 1.508 | 1.511 | 98 | −96 | Disk-like | 0.7 | 6 | 35 | n/a |
| (Example) | | | | | | | | liquid | | | | |
| | | | | | | | | crystal | | | | |

| | Optical film (A layer + B layer) | | | | | LCD evaluation | |
|---|---|---|---|---|---|---|---|
| | Total | | | | Evaluation | Black | |
| | thickness | \|Re\| | \|Rth\| | (\|Re\|/ | of transport | luminance at | Display |
| Film No. | μm | nm | nm | \|Rth\|) + 0.5 | properties | viewing angle | unevenness |
| 15 | 21.5 | 390 | 46 | 0.62 | B | A | AA |
| (Example) | | | | | | | |
| 16 | 22 | 327 | −15 | 0.55 | B | AA | AA |
| (Example) | | | | | | | |
| 17 | 21.2 | 393 | 99 | 0.75 | B | B | AA |
| (Example) | | | | | | | |
| 18 | 20.7 | 408 | 165 | 0.90 | B | C | A |
| (Example) | | | | | | | |

TABLE 5

| | A layer | | | | | | | B layer | | | | |
|---|---|---|---|---|---|---|---|---|---|---|---|---|
| | | Film | | | | | | | Film | | | |
| | Material | thickness | | | | Re | Rth | | thickness | Re | Rth | |
| Film No. | *1 | μm | nx | ny | nz | nm | nm | Material | μm | nm | nm | C layer |
| 19 | P1 | 20 | 1.510 | 1.508 | 1.511 | 101 | −99 | Disk-like | 2.0 | 2 | 101 | n/a |
| (Example) | | | | | | | | liquid | | | | |
| | | | | | | | | crystal | | | | |
| 20 | P1 | 20 | 1.510 | 1.508 | 1.511 | 105 | −100 | Polyimide | 2.0 | 2 | 102 | n/a |
| (Example) | | | | | | | | | | | | |
| 21 | P1 | 20 | 1.510 | 1.508 | 1.511 | 101 | −97 | Poly- | 2.0 | 4 | 103 | n/a |
| (Example) | | | | | | | | carbonate | | | | |
| 22 | P2 | 20 | 1.520 | 1.520 | 1.521 | 99 | −96 | Disk-like | 2.0 | 3 | 100 | n/a |
| (Example) | | | | | | | | liquid | | | | |
| | | | | | | | | crystal | | | | |
| 23 | P3 | 20 | 1.520 | 1.520 | 1.521 | 105 | −104 | Disk-like | 2.0 | 5 | 104 | n/a |
| (Example) | | | | | | | | liquid | | | | |
| | | | | | | | | crystal | | | | |
| 24 | P4 | 20 | 1.488 | 1.487 | 1.492 | 98 | −100 | Disk-like | 2.0 | 0 | 99 | n/a |
| (Example) | | | | | | | | liquid | | | | |
| | | | | | | | | crystal | | | | |
| 25 | P5 | 20 | 1.487 | 1.487 | 1.492 | 102 | −100 | Disk-like | 2.0 | 6 | 98 | n/a |
| (Example) | | | | | | | | liquid | | | | |
| | | | | | | | | crystal | | | | |

| | Optical film (A layer + B layer) | | | | | LCD evaluation | |
|---|---|---|---|---|---|---|---|
| | Total | | | | Evaluation | Black | |
| | thickness | \|Re\| | \|Rth\| | (\|Re\|/ | of transport | luminance at | Display |
| Film No. | μm | nm | nm | \|Rth\|) + 0.5 | properties | viewing angle | unevenness |
| 19 | 22 | 315 | −13 | 0.54 | B | AA | AA |
| (Example) | | | | | | | |
| 20 | 22 | 311 | −7 | 0.52 | B | AA | AA |
| (Example) | | | | | | | |
| 21 | 22 | 300 | −11 | 0.54 | B | A | A |
| (Example) | | | | | | | |
| 22 | 22 | 315 | −20 | 0.56 | B | AA | AA |
| (Example) | | | | | | | |
| 23 | 22 | 305 | 4 | 0.51 | B | AA | AA |
| (Example) | | | | | | | |
| 24 | 22 | 310 | −15 | 0.55 | B | AA | AA |
| (Example) | | | | | | | |
| 25 | 22 | 312 | 0 | 0.50 | B | AA | AA |
| (Example) | | | | | | | |

*1: “P2” is polystyrene “G9504” manufactured by PS Japan Corporation, “P3” is a styrene-maleic anhydride copolymer “D332” manufactured by NOVA Chemicals Corporation, “P4” is a resin manufactured in the same manner as in the synthesis example of Example 1 of JP2006-328132A, and “P5” is a resin manufactured in the same manner as in the synthesis example of Example 2 of JP2006-328132A.

TABLE 6

| | A layer | | | | | | | B layer | | | | |
|---|---|---|---|---|---|---|---|---|---|---|---|---|
| | | Film | | | | | | | Film | | | |
| | Material | thickness | | | | Re | Rth | | thickness | Re | Rth | |
| Film No. | *1 | μm | nx | ny | nz | nm | nm | Material | μm | nm | nm | C layer |
| 26 | P4 | 20 | 1.488 | 1.487 | 1.492 | 85 | −85 | Disk-like | 3.2 | 2 | 161 | n/a |
| (Example) | | | | | | | | liquid | | | | |
| | | | | | | | | crystal | | | | |
| 27 | P4 | 20 | 1.488 | 1.487 | 1.492 | 102 | −120 | Disk-like | 2.6 | 2 | 132 | n/a |
| (Example) | | | | | | | | liquid | | | | |
| | | | | | | | | crystal | | | | |
| 28 | P4 | 20 | 1.488 | 1.487 | 1.492 | 153 | −76 | Disk-like | 1.5 | 0 | 69 | n/a |
| (Example) | | | | | | | | liquid | | | | |
| | | | | | | | | crystal | | | | |
| 29 | P4 | 20 | 1.488 | 1.487 | 1.492 | 103 | −103 | Disk-like | 2.0 | 0 | 100 | Present |
| (Example) | | | | | | | | liquid | | | | *2 |
| | | | | | | | | crystal | | | | |

| | Optical film (A layer + B layer) | | | | | LCD evaluation | |
|---|---|---|---|---|---|---|---|
| | Total | | | | Evaluation | Black | |
| | thickness | \|Re\| | \|Rth\| | (\|Re\|/ | of transport | luminance at | Display |
| Film No. | μm | nm | nm | \|Rth\|) + 0.5 | properties | viewing angle | unevenness |
| 26 | 23.2 | 141 | 19 | 0.64 | B | A | AA |
| (Example) | | | | | | | |
| 27 | 22.6 | 277 | 5 | 0.52 | B | AA | AA |
| (Example) | | | | | | | |
| 28 | 21.5 | 298 | 30 | 0.60 | B | B | A |
| (Example) | | | | | | | |
| 29 | 22 | 309 | −5 | 0.51 | A | AA | AA |
| (Example) | | | | | | | |

*1: “P4” is a resin manufactured in the same manner as in the synthesis example of Example 1 of JP2006-328132A.
*2: a layer containing cellulose acetate as a main component and having a thickness of 40 μm

What is claimed is:

1. An optical film comprising:
a retardation layer A (A layer) satisfying the following relational expression,
nz>nx≧ny
here, nx represents an in-plane refractive index in a direction of an in-plane slow axis, ny represents an in-plane refractive index in a direction orthogonal to the direction of an in-plane slow axis, and nz represents a refractive index in a thickness direction; and
a retardation layer B (B layer) of which in-plane retardation Re and thickness direction retardation Rth satisfy the following relational expressions,
0 nm≦Re≦20 nm
50 nm≦Rth≦300 nm,
wherein the total film thickness is 5 μm to 40 μm.

2. The optical film according to claim 1,
wherein Re and Rth of the A layer satisfy the following relational expressions.
50 nm≦Re≦150 nm
−150 nm≦Rth≦−50 nm

3. The optical film according to claim 1,
wherein Re and Rth of the whole film as a multilayer film satisfy the following relational expression.
0.5≦|Rth|/|Re|+0.5≦0.8

4. The optical film according to claim 3,
wherein Re and Rth of the A layer satisfy the following relational expressions.
50 nm≦Re≦150 nm
−150 nm≦Rth≦−50 nm

5. The optical film according to claim 1,
wherein Re and Rth of the whole film as a multilayer film satisfy the following relational expression.
0.5≦Rth|/|Re|+0.5≦0.7

6. The optical film according to claim 2,
wherein Re and Rth of the whole film as a multilayer film satisfy the following relational expression.
0.5≦|Rth|/|Re|+0.5≦0.7

7. The optical film according to claim 3,
wherein Re and Rth of the whole film as a multilayer film satisfy the following relational expression.
0.5≦|Rth|/|Re|+0.5≦0.7

8. The optical film according to claim 4,
wherein Re and Rth of the whole film as a multilayer film satisfy the following relational expression.
0.5≦|Rth|/|Re|+0.5≦0.7

9. The optical film according to claim 1,
wherein the total film thickness is 5 μm to 30 μm.

10. The optical film according to claim 1,
wherein the B layer contains at least one kind of a discotic liquid crystalline polymer or a polyimide resin.

11. The optical film according to claim 1,
wherein the A layer contains at least one kind selected from a cellulose acylate having an aromatic ring, a styrene-based resin, and a polyester-based resin.

12. A polarizing plate at least comprising:
a polarizer; and
the optical film according to claim 1.

13. The polarizing plate according to claim 12,
wherein the thickness of the polarizer is 10 μm or less.

14. A liquid crystal display device at least comprising:
the optical film according to claim 1; or
a polarizing plate at least including a polarizer and the optical film according to claim 1.

15. A multilayer film comprising:
the optical film according to claim 1; and
a laminate layer C (C layer) on the surface of the A layer of the optical film.

16. The multilayer film according to claim 15,
wherein the C layer contains at least one kind of thermoplastic resin.

17. The multilayer film according to claim 15,
wherein the C layer contains at least one kind of cellulose acetate.

18. A manufacturing method of a multilayer film which is the multilayer film according to claim 12, comprising:
manufacturing a multilayer structure including the A layer and the C layer by a solution co-casting method; and
forming the B layer on the surface of the A layer of the multilayer structure by coating.

19. A manufacturing method of an optical film which is the optical film according to claim 1, comprising:
preparing a multilayer film that has the optical film according to claim 1 and a laminate layer C (C layer) on the surface of the A layer of the optical film; and
peeling the C layer from the multilayer film.

20. The method according to claim 19, further comprising forming an adhesive layer on the surface of the A layer exposed due to peeling of the C layer.
